(19) United States
(12) Patent Application Publication
(10) Pub. No.: US 2023/0345473 A1
(43) Pub. Date: Oct. 26, 2023

(54) CONFIGURED GRANT ENHANCEMENTS FOR EXTENDED REALITY UPLINK TRAFFIC

(71) Applicant: QUALCOMM Incorporated, San Diego, CA (US)

(72) Inventors: Yuchul Kim, San Diego, CA (US); Linhai He, San Diego, CA (US); Huilin Xu, Temecula, CA (US); Jay Kumar Sundararajan, San Diego, CA (US); Nicolas Cornillet, Lannion (FR); Adrien Raphael Julian Pouille, Lannion (FR); Diana Maamari, San Diego, CA (US); Aziz Gholmieh, Del Mar, CA (US); Peter Gaal, San Diego, CA (US)

(21) Appl. No.: 18/304,165

(22) Filed: Apr. 20, 2023

Related U.S. Application Data
(60) Provisional application No. 63/340,913, filed on May 11, 2022.
(60) Provisional application No. 63/334,642, filed on Apr. 25, 2022.

(51) Int. Cl. H04W 72/1268; H04W 72/23

(52) U.S. Cl. CPC H04W 72/1268; H04W 72/23

(57) ABSTRACT

Methods, systems, and devices for wireless communications are described. In some systems, a user equipment (UE) and a network entity may support a configured grant (CG)-specific retransmission timer configuration based on a traffic type to be communicated using a given CG. For example, the network entity may indicate a CG for uplink transmissions and may indicate a retransmission timer that is specific to the CG. As such, the UE may transmit a data message in accordance with the CG and may select a time period during which to monitor a downlink control channel for control information indicating a retransmission request for the data message in accordance with a value of the retransmission timer. Additionally, or alternatively, the UE and the network entity may support a downlink-to-uplink configuration dependency for determining an uplink periodicity of a CG based on a downlink periodicity.

### CROSS REFERENCE

The present Application for Patent claims the benefit of U.S. Provisional Patent Application No. 63/340,913 by KIM et al., entitled “CONFIGURED GRANT ENHANCEMENTS FOR EXTENDED REALITY UPLINK TRAFFIC,” filed May 11, 2022, and the benefit of U.S. Provisional Patent Application No. 63/334,642 by KIM et al., entitled “CONFIGURED GRANT ENHANCEMENTS FOR EXTENDED REALITY UPLINK TRAFFIC,” filed Apr. 25, 2022, each of which is assigned to the assignee hereof, and each of which is expressly incorporated by reference herein.

### TECHNICAL FIELD

The following relates to wireless communications, including configured grant (CG) enhancements for extended reality (XR) uplink traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support configured grant (CG) enhancements for extended reality (XR) uplink traffic. For example, the described techniques provide for CG-specific retransmission timer configurations. For example, a network entity may indicate one or more CGs to a user equipment (UE) and may further indicate potentially different retransmission timers associated with each of the one or more CGs. Such retransmission timers may define a time period after a data transmission on a CG during which a UE monitors a physical downlink control channel (PDCCH) for downlink control information (DCI) associated with scheduling a retransmission of the data transmission. In some implementations, a network entity may indicate a retransmission timer that is specific to a CG based on a traffic type to be communicated on that CG. For example, a network entity may indicate a first retransmission timer value for a first CG that carries a low-latency traffic type and may indicate a second retransmission timer value for a second CG that carries a non-low-latency traffic type.

A method for wireless communication at a UE is described. The method may include receiving, via one or more control messages, an indication of a CG for uplink transmissions and a retransmission timer that is specific to the CG, transmitting a data message in accordance with the CG, and selecting a time period to monitor a downlink control channel for control information associated with scheduling a retransmission of the data message in accordance with the retransmission timer that is specific to the CG.

An apparatus for wireless communication at a UE is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to receive, via one or more control messages, an indication of a CG for uplink transmissions and a retransmission timer that is specific to the CG, transmit a data message in accordance with the CG, and select a time period to monitor a downlink control channel for control information associated with scheduling a retransmission of the data message in accordance with the retransmission timer that is specific to the CG.

Another apparatus for wireless communication at a UE is described. The apparatus may include means for receiving, via one or more control messages, an indication of a CG for uplink transmissions and a retransmission timer that is specific to the CG, means for transmitting a data message in accordance with the CG, and means for selecting a time period to monitor a downlink control channel for control information associated with scheduling a retransmission of the data message in accordance with the retransmission timer that is specific to the CG.

A non-transitory computer-readable medium storing code for wireless communication at a UE is described. The code may include instructions executable by at least one processor (e.g., directly, indirectly, after pre-processing, or without pre-processing) to receive, via one or more control messages, an indication of a CG for uplink transmissions and a retransmission timer that is specific to the CG, transmit a data message in accordance with the CG, and select a time period to monitor a downlink control channel for control information associated with scheduling a retransmission of the data message in accordance with the retransmission timer that is specific to the CG.

Some examples of the method, apparatuses, and non-transitory computer-readable medium described herein may further include operations, features, means, or instructions for monitoring the downlink control channel for the control information in accordance with the retransmission timer indicating a non-zero value.

In some examples of the method, apparatuses, and non-transitory computer-readable medium described herein, the retransmission timer that may be specific to the CG indicates the non-zero value based on the data message to be communicated on the CG being associated with a non-low-latency traffic type and the time period may be equal to a non-zero quantity of milliseconds in accordance with the retransmission timer indicating the non-zero value.

In some examples of the method, apparatuses, and non-transitory computer-readable medium described herein, selecting the time period to monitor the downlink control channel for the control information may include operations, features, means, or instructions for selecting not to monitor the downlink control channel for the control information in accordance with the retransmission timer indicating a zero value.

In some examples of the method, apparatuses, and non-transitory computer-readable medium described herein, the retransmission timer that may be specific to the CG indicates the zero value based on the data message to be communicated on the CG being associated with a low-latency traffic type and the time period may be equal to zero milliseconds in accordance with the retransmission timer indicating the zero value.

In some examples of the method, apparatuses, and non-transitory computer-readable medium described herein, receiving the one or more control messages may include operations, features, means, or instructions for receiving an indication to disable retransmission for the CG, where the indication to disable retransmission may be specific to the CG and setting the retransmission timer to a zero value in accordance with the indication to disable retransmission for the CG, where selecting the time period to monitor the downlink control channel may be further in accordance with setting the retransmission timer to the zero value.

In some examples of the method, apparatuses, and non-transitory computer-readable medium described herein, setting the retransmission timer to the zero value may include operations, features, means, or instructions for disabling the retransmission timer. In some examples of the method, apparatuses, and non-transitory computer-readable medium described herein, disabling the retransmission timer may include operations, features, means, or instructions for disabling one or more of a set of retransmission timers associated with the retransmission timer, where the set of retransmission timers includes one or more of a CG timer, a hybrid automatic repeat request (HARD) timer, or an uplink discontinuous reception (DRX) retransmission timer.

Some examples of the method, apparatuses, and non-transitory computer-readable medium described herein may further include operations, features, means, or instructions for initiating a radio link control unacknowledged mode at the UE in accordance with receiving the indication to disable retransmission for the CG.

Some examples of the method, apparatuses, and non-transitory computer-readable medium described herein may further include operations, features, means, or instructions for transmitting, with the data message and in accordance with the configured grant, an indication of whether to start the retransmission timer, where selecting the time period to monitor the downlink control channel may be further in accordance with the indication of whether to start the retransmission timer.

In some examples of the method, apparatuses, and non-transitory computer-readable medium described herein, the indication may be a bit transmitted with the data message, a bit value of 1 indicates that the retransmission timer is to be started, a bit value of 0 indicates that the retransmission timer is not to be started, and selecting the time period may be associated with whether the retransmission is to be started.

Some examples of the method, apparatuses, and non-transitory computer-readable medium described herein may further include operations, features, means, or instructions for transmitting, with the data message and in accordance with the configured grant, a buffer status report (BSR), where selecting the time period to monitor the downlink control channel may be further in accordance with the BSR being transmitted with the data message.

In some examples of the method, apparatuses, and non-transitory computer-readable medium described herein, a transmission of the BSR with the data message indicates that the retransmission timer is to be started, an absence of the BSR with the data message indicates that the retransmission timer is not to be started, and selecting the time period may be associated with whether the retransmission is to be started.

In some examples of the method, apparatuses, and non-transitory computer-readable medium described herein, the retransmission timer may be specific to a logical channel over which the UE transmits the data message and the CG may be mapped to the logical channel in accordance with a traffic type of the data message to be communicated on the CG.

Some examples of the method, apparatuses, and non-transitory computer-readable medium described herein may further include operations, features, means, or instructions for transmitting a second data message in accordance with a second CG during a same slot as the data message and the CG based on the retransmission timer that may be specific to the CG indicating a zero value.

In some examples of the method, apparatuses, and non-transitory computer-readable medium described herein, the second data message and the data message can be transmitted during the same slot if the CG and the second CG may be contiguous in a frequency domain.

Some examples of the method, apparatuses, and non-transitory computer-readable medium described herein may further include operations, features, means, or instructions for receiving the control information associated with scheduling the retransmission of the data message and ignoring the control information in accordance with the retransmission timer that may be specific to the CG indicating a zero value.

In some examples of the method, apparatuses, and non-transitory computer-readable medium described herein, the retransmission timer indicates a relatively smaller value if the data message may be associated with a low-latency traffic type and indicates a relatively larger value if the data message may be associated with a non-low-latency traffic type.

In some examples of the method, apparatuses, and non-transitory computer-readable medium described herein, the retransmission timer may be a CG timer parameter or an uplink discontinuous reception (DRX) retransmission timer parameter.

A method for wireless communication at a UE is described. The method may include receiving, via a first set of one or more control messages, a first set of parameters associated with downlink communication from a network entity to the UE, receiving, via a second set of one or more control messages, an indication of a set of resources for a CG for uplink transmissions, and transmitting, over the set of resources, one or more data messages in accordance with the CG using a second set of parameters that are associated with the first set of parameters associated with the downlink communication from the network entity to the UE.

An apparatus for wireless communication at a UE is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to receive, via a first set of one or more control messages, a first set of parameters associated with downlink communication from a network entity to the UE, receive, via a second set of one or more control messages, an indication of a set of resources for a CG for uplink transmissions, and transmit, over the set of resources, one or more data messages in accordance with the CG using a second set of parameters that are associated with the first set of parameters associated with the downlink communication from the network entity to the UE.

Another apparatus for wireless communication at a UE is described. The apparatus may include means for receiving, via a first set of one or more control messages, a first set of parameters associated with downlink communication from a network entity to the UE, means for receiving, via a second set of one or more control messages, an indication of a set of resources for a CG for uplink transmissions, and means for transmitting, over the set of resources, one or more data messages in accordance with the CG using a second set of parameters that are associated with the first set of parameters associated with the downlink communication from the network entity to the UE.

A non-transitory computer-readable medium storing code for wireless communication at a UE is described. The code may include instructions executable by at least one processor (e.g., directly, indirectly, after pre-processing, or without pre-processing) to receive, via a first set of one or more control messages, a first set of parameters associated with downlink communication from a network entity to the UE, receive, via a second set of one or more control messages, an indication of a set of resources for a CG for uplink transmissions, and transmit, over the set of resources, one or more data messages in accordance with the CG using a second set of parameters that are associated with the first set of parameters associated with the downlink communication from the network entity to the UE.

Some examples of the method, apparatuses, and non-transitory computer-readable medium described herein may further include operations, features, means, or instructions for receiving the first set of parameters associated with the downlink communication includes, receiving an indication of a downlink periodicity associated with the downlink communication, transmitting the one or more data messages in accordance with the CG using the second set of parameters includes, and transmitting the one or more data messages in accordance with an uplink periodicity that may be associated with the downlink periodicity.

In some examples of the method, apparatuses, and non-transitory computer-readable medium described herein, the uplink periodicity may be equal to a product of the downlink periodicity and a scaling factor.

Some examples of the method, apparatuses, and non-transitory computer-readable medium described herein may further include operations, features, means, or instructions for determining the uplink periodicity in accordance with a unit conversion from milliseconds to symbols based on the downlink periodicity being defined by milliseconds and the uplink periodicity being defined by symbols.

In some examples of the method, apparatuses, and non-transitory computer-readable medium described herein, the downlink periodicity may be associated with a DRX cycle or a semi-persistent scheduling (SPS) periodicity.

A method for wireless communication at a network entity is described. The method may include transmitting, via one or more control messages, an indication of a CG for uplink transmissions and a retransmission timer that is specific to the CG, receiving a data message in accordance with the CG, and selecting a time period during which to transmit control information associated with scheduling a retransmission of the data message in accordance with the retransmission timer that is specific to the CG.

An apparatus for wireless communication at a network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to transmit, via one or more control messages, an indication of a CG for uplink transmissions and a retransmission timer that is specific to the CG, receive a data message in accordance with the CG, and select a time period during which to transmit control information associated with scheduling a retransmission of the data message in accordance with the retransmission timer that is specific to the CG.

Another apparatus for wireless communication at a network entity is described. The apparatus may include means for transmitting, via one or more control messages, an indication of a CG for uplink transmissions and a retransmission timer that is specific to the CG, means for receiving a data message in accordance with the CG, and means for selecting a time period during which to transmit control information associated with scheduling a retransmission of the data message in accordance with the retransmission timer that is specific to the CG.

A non-transitory computer-readable medium storing code for wireless communication at a network entity is described. The code may include instructions executable by at least one processor (e.g., directly, indirectly, after pre-processing, or without pre-processing) to transmit, via one or more control messages, an indication of a CG for uplink transmissions and a retransmission timer that is specific to the CG, receive a data message in accordance with the CG, and select a time period during which to transmit control information associated with scheduling a retransmission of the data message in accordance with the retransmission timer that is specific to the CG.

Some examples of the method, apparatuses, and non-transitory computer-readable medium described herein may further include operations, features, means, or instructions for transmitting the control information in accordance with the retransmission timer indicating a non-zero value and a failure to receive the data message.

In some examples of the method, apparatuses, and non-transitory computer-readable medium described herein, the retransmission timer that may be specific to the CG indicates the non-zero value based on the data message to be communicated on the CG being associated with a non-low-latency traffic type and the time period may be equal to a non-zero quantity of milliseconds in accordance with the retransmission timer indicating the non-zero value.

In some examples of the method, apparatuses, and non-transitory computer-readable medium described herein, selecting the time period during which to transmit the control information may include operations, features, means, or instructions for selecting not to transmit the control information in accordance with the retransmission timer indicating a zero value.

In some examples of the method, apparatuses, and non-transitory computer-readable medium described herein, the retransmission timer that may be specific to the CG indicates the zero value based on the data message to be communicated on the CG being associated with a low-latency traffic type and the time period may be equal to zero milliseconds in accordance with the retransmission timer indicating the zero value.

In some examples of the method, apparatuses, and non-transitory computer-readable medium described herein, transmitting the one or more control messages may include operations, features, means, or instructions for transmitting an indication to disable retransmission for the CG, where the indication to disable retransmission may be specific to the CG and setting the retransmission timer to a zero value in accordance with the indication to disable retransmission for the CG, where selecting the time period during which to transmit the control information may be further in accordance with setting the retransmission timer to the zero value.

In some examples of the method, apparatuses, and non-transitory computer-readable medium described herein, setting the retransmission timer to the zero value may include operations, features, means, or instructions for disabling the retransmission timer. In some examples of the method, apparatuses, and non-transitory computer-readable medium described herein, disabling the retransmission timer may include operations, features, means, or instructions for disabling one or more of a set of retransmission timers associated with the retransmission timer, where the set of retransmission timers includes one or more of a CG timer, a HARQ timer, or an uplink DRX retransmission timer.

Some examples of the method, apparatuses, and non-transitory computer-readable medium described herein may further include operations, features, means, or instructions for initiating a radio link control unacknowledged mode in accordance with receiving the indication to disable retransmission for the CG.

Some examples of the method, apparatuses, and non-transitory computer-readable medium described herein may further include operations, features, means, or instructions for receiving, with the data message and in accordance with the configured grant, a BSR, where selecting the time period during which to transmit the control information may be further in accordance with the BSR being transmitted with the data message.

In some examples of the method, apparatuses, and non-transitory computer-readable medium described herein, the indication may be a bit received with the data message, a bit value of 1 indicates that the retransmission timer is to be started, a bit value of 0 indicates that the retransmission timer is not to be started, and selecting the time period may be associated with whether the retransmission is to be started.

Some examples of the method, apparatuses, and non-transitory computer-readable medium described herein may further include operations, features, means, or instructions for receiving, with the data message and in accordance with the configured grant, a BSR, where selecting the time period during which to transmit the control information may be further in accordance with the BSR being transmitted with the data message.

In some examples of the method, apparatuses, and non-transitory computer-readable medium described herein, a reception of the BSR with the data message indicates that the retransmission timer is to be started, an absence of the BSR with the data message indicates that the retransmission timer is not to be started, and selecting the time period may be associated with whether the retransmission is to be started.

In some examples of the method, apparatuses, and non-transitory computer-readable medium described herein, the retransmission timer may be specific to a logical channel over which the data message may be received and the CG may be mapped to the logical channel in accordance with a traffic type of the data message to be communicated on the CG.

Some examples of the method, apparatuses, and non-transitory computer-readable medium described herein may further include operations, features, means, or instructions for receiving a second data message in accordance with a second CG during a same slot as the data message and the CG based on the retransmission timer that may be specific to the CG indicating a zero value.

In some examples of the method, apparatuses, and non-transitory computer-readable medium described herein, the second data message and the data message can be transmitted during the same slot if the CG and the second CG may be contiguous in a frequency domain.

Some examples of the method, apparatuses, and non-transitory computer-readable medium described herein may further include operations, features, means, or instructions for transmitting the control information associated with scheduling the retransmission of the data message and failing to receive the retransmission in accordance with the retransmission timer that may be specific to the CG indicating a zero value.

In some examples of the method, apparatuses, and non-transitory computer-readable medium described herein, the retransmission timer indicates a relatively smaller value if the data message may be associated with a low-latency traffic type and indicates a relatively larger value if the data message may be associated with a non-low-latency traffic type.

In some examples of the method, apparatuses, and non-transitory computer-readable medium described herein, the retransmission timer may be a CG timer parameter or an uplink DRX retransmission timer parameter.

A method for wireless communication at a network entity is described. The method may include transmitting, via a first set of one or more control messages, a first set of parameters associated with downlink communication from the network entity to a UE, transmitting, via a second set of one or more control messages, an indication of a set of resources for a CG for uplink transmissions, and receiving, over the set of resources, one or more data messages in accordance with the CG using a second set of parameters that are associated with the first set of parameters associated with the downlink communication from the network entity to the UE.

An apparatus for wireless communication at a network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the apparatus to transmit, via a first set of one or more control messages, a first set of parameters associated with downlink communication from the network entity to a UE, transmit, via a second set of one or more control messages, an indication of a set of resources for a CG for uplink transmissions, and receive, over the set of resources, one or more data messages in accordance with the CG using a second set of parameters that are associated with the first set of parameters associated with the downlink communication from the network entity to the UE.

Another apparatus for wireless communication at a network entity is described. The apparatus may include means for transmitting, via a first set of one or more control messages, a first set of parameters associated with downlink communication from the network entity to a UE, means for transmitting, via a second set of one or more control messages, an indication of a set of resources for a CG for uplink transmissions, and means for receiving, over the set of resources, one or more data messages in accordance with the CG using a second set of parameters that are associated with the first set of parameters associated with the downlink communication from the network entity to the UE.

A non-transitory computer-readable medium storing code for wireless communication at a network entity is described. The code may include instructions executable by at least one processor (e.g., directly, indirectly, after pre-processing, or without pre-processing) to transmit, via a first set of one or more control messages, a first set of parameters associated with downlink communication from the network entity to a UE, transmit, via a second set of one or more control messages, an indication of a set of resources for a CG for uplink transmissions, and receive, over the set of resources, one or more data messages in accordance with the CG using a second set of parameters that are associated with the first set of parameters associated with the downlink communication from the network entity to the UE.

Some examples of the method, apparatuses, and non-transitory computer-readable medium described herein may further include operations, features, means, or instructions for transmitting the first set of parameters associated with the downlink communication includes, transmitting an indication of a downlink periodicity associated with the downlink communication, receiving the one or more data messages in accordance with the CG using the second set of parameters includes, and receiving the one or more data messages in accordance with an uplink periodicity that may be associated with the downlink periodicity.

In some examples of the method, apparatuses, and non-transitory computer-readable medium described herein, the uplink periodicity may be equal to a product of the downlink periodicity and a scaling factor.

Some examples of the method, apparatuses, and non-transitory computer-readable medium described herein may further include operations, features, means, or instructions for determining the uplink periodicity in accordance with a unit conversion from milliseconds to symbols based on the downlink periodicity being defined by milliseconds and the uplink periodicity being defined by symbols.

In some examples of the method, apparatuses, and non-transitory computer-readable medium described herein, the downlink periodicity may be associated with a DRX cycle or an SPS periodicity.

### BRIEF DESCRIPTION OF THE DRAWINGS

FIGS. 1 and 2 show examples of wireless communications systems that support configured grant (CG) enhancements for extended reality (XR) uplink traffic in accordance with one or more aspects of the present disclosure.

FIG. 3 shows examples of CG-specific retransmission timer configurations that support CG enhancements for XR uplink traffic in accordance with one or more aspects of the present disclosure.

FIGS. 4 and 5 show examples of communication timelines that support CG enhancements for XR uplink traffic in accordance with one or more aspects of the present disclosure.

FIGS. 6 and 7 show examples of process flows that support CG enhancements for XR uplink traffic in accordance with one or more aspects of the present disclosure.

FIGS. 8 and 9 show block diagrams of devices that support CG enhancements for XR uplink traffic in accordance with one or more aspects of the present disclosure.

FIG. 10 shows a block diagram of a communications manager that supports CG enhancements for XR uplink traffic in accordance with one or more aspects of the present disclosure.

FIG. 11 shows a diagram of a system including a device that supports CG enhancements for XR uplink traffic in accordance with one or more aspects of the present disclosure.

FIGS. 12 and 13 show block diagrams of devices that support CG enhancements for XR uplink traffic in accordance with one or more aspects of the present disclosure.

FIG. 14 shows a block diagram of a communications manager that supports CG enhancements for XR uplink traffic in accordance with one or more aspects of the present disclosure.

FIG. 15 shows a diagram of a system including a device that supports CG enhancements for XR uplink traffic in accordance with one or more aspects of the present disclosure.

FIGS. 16 through 19 show flowcharts illustrating methods that support CG enhancements for XR uplink traffic in accordance with one or more aspects of the present disclosure.

### DETAILED DESCRIPTION

In some wireless communications systems, a user equipment (UE) may transmit data to a network entity using preconfigured time and frequency resources. For example, the UE may receive an indication of a configured grant (CG), such as a CG physical uplink shared channel (PUSCH), and may transmit data to the network entity in accordance with the CG based on one or both of a configuration or activation of the CG. The network entity, in addition to indicating or configuring the CG for the UE, may indicate one or more timers associated with a potential retransmission of data sent using the CG. For example, the network entity may indicate a retransmission timer for a CG and the retransmission timer may define a time period during which the UE is expected to monitor for downlink control information (DCI) that may request a retransmission of the data that the UE sent to the network entity using the CG. In some systems, the network entity may indicate or configure a same retransmission timer for each configured or activated CG, regardless of an uplink traffic type associated with that CG. Retransmissions for some uplink traffic types (e.g., for low-latency uplink traffic types), however, may be less useful or less likely to be requested by the network entity, which may result in unnecessary monitoring for a retransmission request for such traffic types when sent in accordance with a CG. As such, any DCI monitoring-related power consumption at the UE may be wasted.

In some implementations of the present disclosure, a UE and a network entity may support CG-specific retransmission timer configurations such that a retransmission timer that is configured for a CG is specific to the CG. In other words, the UE and the network entity may support different retransmission timer values for different CGs, such as for CGs that carry different uplink traffic types. For example, the UE and the network entity may support a first retransmission timer value (e.g., a retransmission timer value of zero) for a first CG that carries low-latency uplink traffic and may support a second retransmission timer value (e.g., a non-zero value) for a second CG that carries non-low-latency uplink traffic. In some implementations, such as implementations associated with an extended reality (XR) application at the UE, such low-latency uplink traffic may include pose information and such non-low-latency traffic may include scene information.

In some additional, or alternative, implementations of the present disclosure, a UE and a network entity may support a downlink-to-uplink configuration dependency for CG resources. For example, the UE and the network entity may support a mapping rule according to which the UE and the network entity compute, select, ascertain, or otherwise determine an uplink CG periodicity based on one or both of a downlink discontinuous reception (DRX) cycle length or a downlink semi-persistent scheduling (SPS) periodicity. As such, the UE may receive an indication of a downlink DRX cycle length or a downlink SPS periodicity and may compute, select, ascertain, or otherwise determine an uplink CG periodicity based on the indicated downlink DRX cycle length or downlink SPS periodicity and the mapping rule. In some aspects, the mapping rule may include one or both of an application of a scaling factor or a unit conversion.

Particular implementations of the subject matter described in this disclosure can be implemented to realize one or more of the following potential advantages. For example, as a result of supporting variable (and potentially zero) values for a retransmission timer associated with a CG based on an uplink traffic type to be communicated in accordance with the CG (such that the retransmission timer is specific to the CG), a UE may avoid monitoring for DCI that might request a retransmission if the data sent using the CG is poorly suited for retransmission. As such, the UE may consume less battery power and achieve greater power savings, which may increase a battery life of the UE while also supporting lower latency communication. Further, in accordance with supporting a retransmission timer value of zero, a network entity may schedule a UE with multiple CG transmissions in a same slot, as the network entity and the UE may preclude a scheduling conflict if at least one of the multiple CG transmissions in the slot is not expected to have any retransmission. As such, the UE and the network entity may achieve higher data rates, greater spectral efficiency, and greater system capacity.

Aspects of the disclosure are initially described in the context of wireless communications systems. Aspects of the disclosure are additionally illustrated by and described with reference to CG-specific retransmission timer configurations, communication timelines, and process flows. Aspects of the disclosure are further illustrated by and described with reference to apparatus diagrams, system diagrams, and flowcharts that relate to configured grant enhancements for extended reality uplink traffic.

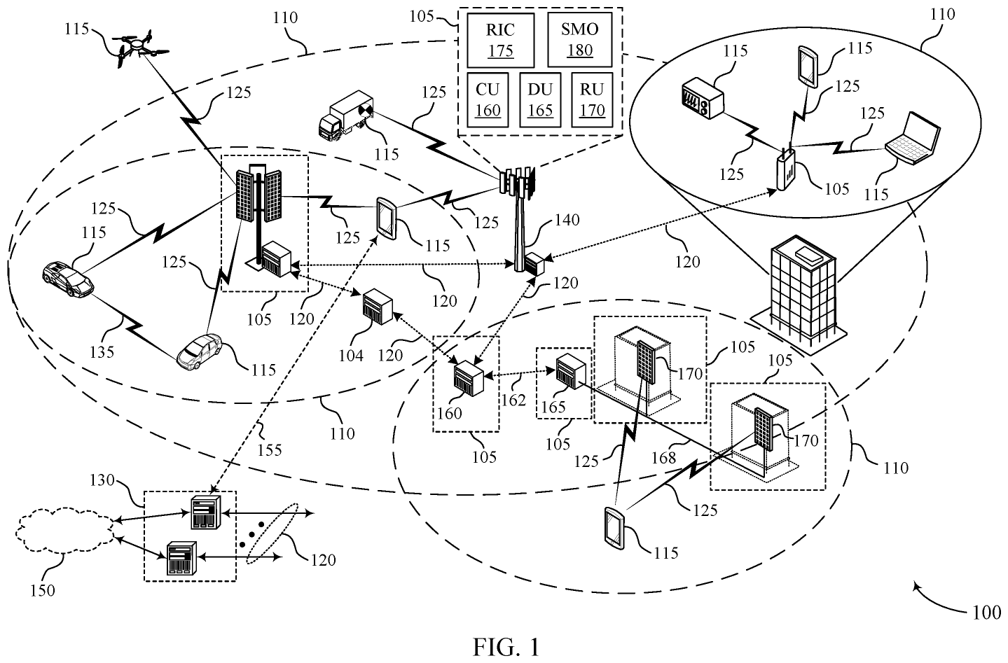

FIG. 1 shows an example of a wireless communications system 100 that supports CG enhancements for XR uplink traffic in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. Components within a wireless communication system may be coupled (for example, operatively, communicatively, functionally, electronically, and/or electrically) with each other (such as coupled to each other).

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support configured grant enhancements for extended reality uplink traffic as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (0f) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some wireless communications systems, such as the wireless communications system 100, a UE 115 may transmit data to a network entity 105 using preconfigured time and frequency resources. For example, the UE 115 may receive an indication of a CG and may transmit data to the network entity 105 via the CG based on one or both of a configuration or activation of the CG. The network entity 105, in addition to indicating or configuring the CG for the UE 115, may indicate one or more timers associated with a potential retransmission of data sent using the CG. For example, the network entity 105 may indicate a retransmission timer for a CG and the retransmission timer may define a time period during which the UE 115 is expected to monitor for DCI that may request a retransmission of the data that the UE 115 sent to the network entity 105 using the CG. In some systems, the network entity 105 may indicate or configure a same retransmission timer for each CG, regardless of an uplink traffic type associated with the CG. Retransmissions for some uplink traffic types (e.g., for low-latency uplink traffic types), however, may be less useful or less likely to be requested by the network entity, which may result in unnecessary monitoring for a retransmission request for such traffic types when sent in accordance with a CG. As such, any DCI monitoring-related power consumption at the UE may be wasted.

In some implementations, a UE 115 and a network entity 105 may support CG-specific retransmission timer configurations such that a retransmission timer that is configured for a CG is specific to the CG. In other words, the UE 115 and the network entity may support different retransmission timer values for different CGs, such as for CGs that carry different uplink traffic types. For example, the UE 115 and the network entity 105 may support a first retransmission timer value (e.g., a retransmission timer value of zero) for a first CG that carries low-latency uplink traffic and may support a second retransmission timer value (e.g., a non-zero value) for a second CG that carries non-low-latency uplink traffic. In some implementations, such as implementations associated with an XR application (which may refer to one or both of virtual reality (VR) or augmented reality (AR)) at the UE 115, such low-latency uplink traffic may include pose information and such non-low-latency traffic may include other information (e.g., scene information). As described herein, a retransmission timer may refer to one or multiples of a drx-HARQ-RTT-TimerUL, drx-RetransmissionTimerUL, or a configuredGrantTimer.

Additionally, or alternatively, a UE 115 and a network entity 105 may support a downlink-to-uplink configuration dependency for CG resources. For example, the UE 115 and the network entity 105 may support a mapping rule according to which the UE 115 and the network entity 105 compute, select, ascertain, or otherwise determine an uplink CG periodicity based on one or both of a downlink DRX cycle length or a downlink SPS periodicity. As such, the UE 115 may receive an indication of a downlink DRX cycle length or a downlink SPS periodicity and may compute, select, ascertain, or otherwise determine an uplink CG periodicity based on the indicated downlink DRX cycle length or downlink SPS periodicity and the mapping rule. In some aspects, the mapping rule may include one or both of an application of (such as an applying of) a scaling factor or a unit conversion.

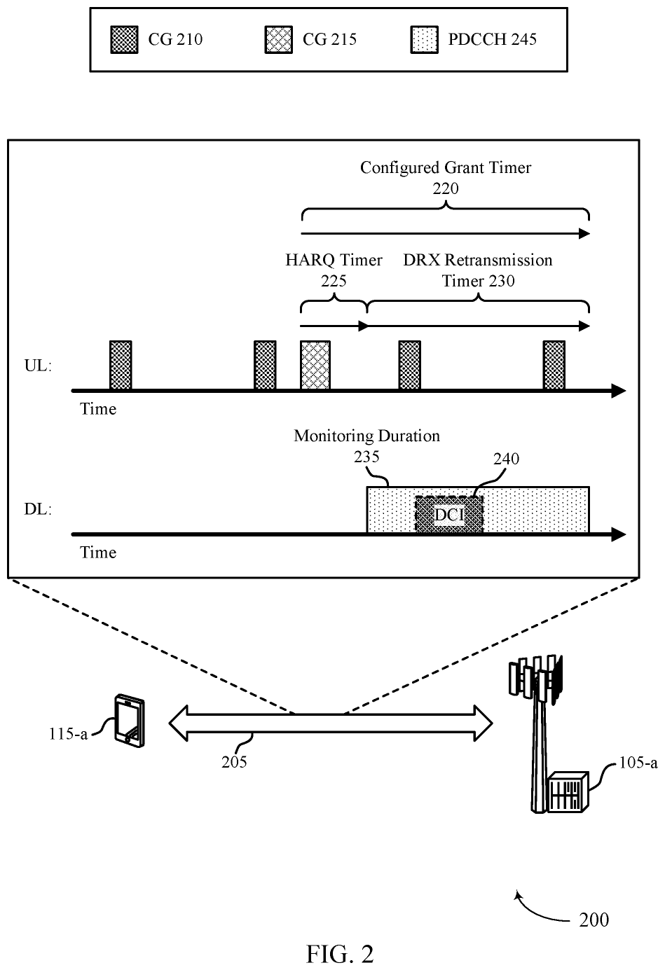

FIG. 2 shows an example of a wireless communications system 200 that supports CG enhancements for XR uplink traffic in accordance with one or more aspects of the present disclosure. In some examples, the wireless communications system 200 may implement aspects of wireless communications system 100. For example, the wireless communications system 200 may include a network entity 105-a and a UE 115-a, which may be examples of the corresponding devices of FIG. 1. The UE 115-a and the network entity 105-a may communicate via a communication link 205 and the UE 115-a may transmit one or more data messages in accordance with a CG 210 (e.g., a first CG) and a CG 215 (e.g., a second CG). The UE 115-a and the network entity 105-a may support one or more timers, such as a configured grant timer 220, a HARQ timer 225, and a DRX retransmission timer 230, associated with each CG. In some implementations, the UE 115-a and the network entity 105-a may support a retransmission timer, which may refer to one or both of the configured grant timer 220 or the DRX retransmission timer 230, that is specific to a given CG.

For example, the UE 115-a may transmit a data message using a PUSCH resource through a preconfigured time-frequency resource with or without receiving DCI on a physical downlink control channel (PDCCH) resource (e.g., with or without PDCCH), and such a preconfigured time-frequency resource may be referred to herein as a CG. In some aspects, some data types might be relatively more suitable for transmission in accordance with a CG than other data types. For example, a suitable traffic type for transmission via a preconfigured time-frequency resource may include data that is periodic or relatively predictable, such as voice over Internet Protocol (VoIP) data, ultra-reliable low-latency communication (URLLC) data, or industrial IoT (IIoT) data. In some aspects, the UE 115-a and the network entity 105-a may support repetition for a CG. For example, the UE 115-a and the network entity 105-a may support repetitions of 1 (e.g., no repetition), 2, 4, and 8 to increase a reliability of data sent in accordance with a CG.

The UE 115-a and the network entity 105-a may support different types of CGs. For example, the UE 115-a and the network entity 105-a may support one or both of a Type 1 CG that is fully configured by radio resource control (RRC) signaling and a Type 2 CG that is partially configured by RRC signaling and partially configured by PDCCH signaling. For a Type 2 CG, RRC signaling may indicate one or more of a periodicity, a repetition factor (e.g., repK), and one or more power control parameters for a CG and PDCCH signaling (e.g., DCI) may indicate one or more of activation or deactivation, a time or frequency resource allocation, and a modulation and coding scheme (MCS) for the CG.

The UE 115-a and the network entity 105-a may support one or more CG configurations and a quantity of CG configurations that the UE 115-a and the network entity 105-a support may depend on a deployment scenario. In some deployment scenarios, for example, the UE 115-a and the network entity 105-a may support one CG configuration. In some other deployment scenarios, the UE 115-a and the network entity 105-a may support multiple CG configurations. In deployment scenarios in which the UE 115-a and the network entity 105-a support multiple CG configurations, the UE 115-a and the network entity 105-a may support a deactivation for multiple CGs via one DCI and may support an activation for one CG per DCI (e.g., one DCI for one CG activation). CGs may support relatively lower signaling overhead and relatively lower latency (as timing is fixed) as compared to some other signaling designs and may be associated with preconfigured parameters (such as parameters configured via RRC signaling, which may be relatively static and, likewise, sometimes less flexible or less adaptable).

As part of a configuration of a CG, the network entity 105-a may configure one or more timers related to a CG. Such timers may include a configured grant timer 220 (which may be an example of or defined by a configuredGrantTimer parameter), a HARQ timer 225 (which may be an example of or defined by a drx-HARQ-RTT-TimerUL parameter), and a DRX retransmission timer 230 (which may be an example of or defined by a drx-RetransmissionTimerUL parameter). Each of such timers may be associated with a potential reception of a retransmission request for data sent using a CG and, as such, a retransmission timer may generally refer to any one or more of the configured grant timer 220, the HARQ timer 225, or the DRX retransmission timer 230.

For example, a configured grant timer 220 (e.g., configuredGrantTimer) may define a time duration during which the UE 115-a waits for a potential retransmission of a current CG transmission with a same HARQ process identifier (ID). The UE 115-a may start the configured grant timer 220 when the UE 115-a transmits a CG and the UE 115-a may restart the configured grant timer 220 if the UE 115-a receives a DCI for a retransmission request associated with the CG. The configured grant timer 220 may run independently for each HARQ process ID and an expiration of the configured grant timer 220 may be an implicit indication of an acknowledgment (ACK) for the CG transmission (e.g., for a PUSCH transmission using the CG). The network entity 105-a may configure the configured grant timer 220 with an integer value from 1 to 64 and a configuredGrantTimer parameter may indicate an initial value of the configured grant timer 220 in multiples of periodicity. The UE 115-a may start a HARQ timer 225 (e.g., a drx-HARQ-RTT-TimerUL retransmission timer) whenever the UE 115-a transmits a data message using an uplink CG and, when a HARQ timer 225 expires, the UE 115-a may start a DRX retransmission timer 230 (e.g., a drx-RetransmissionTimerUL retransmission timer). Once the DRX retransmission timer 230 starts, the UE 115-a may stay in an active time mode (e.g., ActiveTime) and monitor a PDCCH 245 for a monitoring duration 235 to potentially receive a DCI 240 triggering a retransmission for the data sent using the uplink CG.

In some systems, the network entity 105-a may configure each CG with a same set of a configured grant timer 220, a HARQ timer 225, and a DRX retransmission timer 230, regardless of a traffic or data type to be communicated in accordance with a given CG. As such, the UE 115-a may be expected to monitor a PDCCH 245 for a duration of a DRX retransmission timer 230 (and not assume an ACK until an expiration of the configured grant timer 220) for each data transmission sent in accordance with a CG, which may result in wasted power consumption for some data transmissions. For example, some traffic or data types may be less suitable for retransmissions (and therefore a corresponding retransmission request from the network entity 105-a may be less likely) than others. For instance, some low-latency traffic types may be relatively poorly suited for retransmissions and monitoring a PDCCH 245 for a retransmission request associated with such low-latency traffic types may result in wasted power consumption at the UE 115-a.

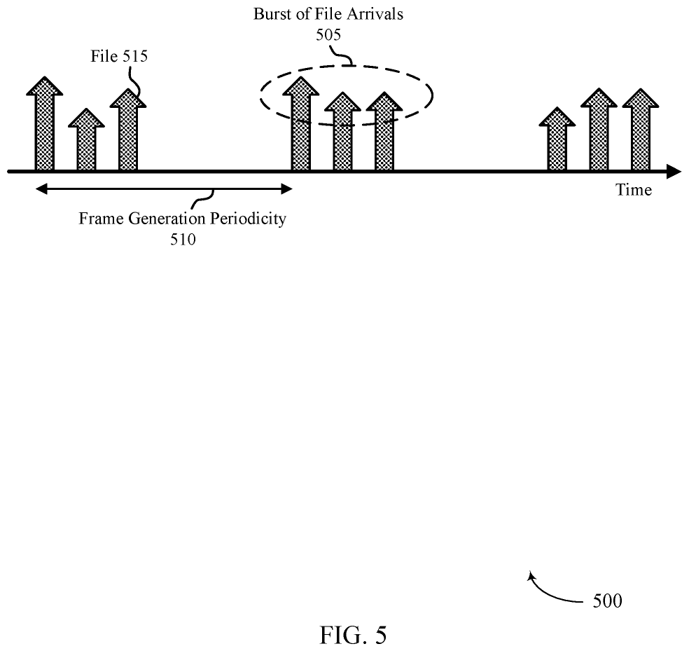

Accordingly, in some implementations, the UE 115-a and the network entity 105-a may support an association of CG configurations with separate retransmission timer values (e.g., CG-specific values for one or more of a configured grant timer 220, a HARQ timer 225, and a DRX retransmission timer 230). For example, the UE 115-a and the network entity 105-a may support relatively smaller values (e.g., including zero values) for one or more of a configured grant timer 220, a HARQ timer 225, or a DRX retransmission timer 230 for a first set of one or more CGs (which may include the CG 210) and relatively larger values for one or more of a configured grant timer 220, a HARQ timer 225, and a DRX retransmission timer 230 for a second set of one or more CGs (which may include the CG 215). In some implementations, for instance, the UE 115-a and the network entity 105-a may support zero values for a configured grant timer 220, a HARQ timer 225, and a DRX retransmission timer 230 for the first set of one or more CGs and non-zero values for a configured grant timer 220, a HARQ timer 225, and a DRX retransmission timer 230 for the second set of one or more CGs. In some examples, the UE 115-a and the network entity 105-a may support the zero values for a configured grant timer 220, a HARQ timer 225, and a DRX retransmission timer 230 for the first set of one or more CGs if a low-latency traffic type (e.g., pose information in an XR application, as described in more detail with reference to FIG. 5) is to be communicated using the first set of one or more CGs and may support the non-zero values for a configured grant timer 220, a HARQ timer 225, and a DRX retransmission timer 230 for the second set of one or more CGs if a non-low-latency traffic type (e.g., scene information in an XR application or other uplink traffic with longer packet delay budget (PDB) constraints, as described in more detail with reference to FIG. 5).

For example, the CG 210 may be associated with relatively smaller or lower latency packet transmissions and, accordingly, the network entity 105-a may indicate a zero value for a retransmission timer (e.g., for one or more of the configured grant timer 220, the HARQ timer 225, or the DRX retransmission timer 230) that is specifically associated with the CG 210. Further, the CG 215 may be associated with relatively larger or medium latency packet transmissions and, accordingly, the network entity 105-a may indicate a non-zero value for a retransmission timer (e.g., for one or more of the configured grant timer 220, the HARQ timer 225, or the DRX retransmission timer 230) that is specifically associated with the CG 215. As such, retransmission may be disabled for the CG 210 by way of the CG 210 being associated with a zero value for a retransmission timer (which may be understood as a disabling of a retransmission timer, such as a disabling of one or more of the configured grant timer 220, the HARQ timer 225, or the DRX retransmission timer 230) while the UE 115-a and the network entity 105-a may support dynamic grant (DG)-based (e.g., DCI-based) retransmission for the CG 215 by way of the CG 215 being associated with a non-zero value for a retransmission timer.

In an example, the UE 115-a may select a time period of zero milliseconds to monitor a PDCCH 245 for a retransmission request associated with a data message sent in accordance with the CG 210 based on the indicated zero value retransmission timer for the CG 210. In another example, the UE 115-a may select a time period of a non-zero number of milliseconds (e.g., 10 milliseconds) to monitor a PDCCH 245 for a retransmission request associated with a data message sent in accordance with the CG 215 based on the indicated non-zero value retransmission timer for the CG 215. As such, the monitoring duration 235 associated with the CG 215 (e.g., as defined by the DRX retransmission timer 230 that is specific to the CG 215) may be equal to the non-zero number of milliseconds (e.g., 10 milliseconds) and the UE 115-a may potentially receive a DCI 240 indicating a retransmission request for data sent in accordance with the CG 215 within the monitoring duration 235.

Additionally, or alternatively, the UE 115-a and the network entity 105-a may allow or otherwise support a disabling of a retransmission for a given CG configuration. In some implementations, for example, the network entity 105-a may transmit an indication to the UE 115-a indicating a disabling of retransmissions for a set of one or more CG configurations. As such, the UE 115-a may refrain from monitoring a PDCCH 245 for a retransmission request for the indicated set of one or more CG configurations and may maintain the possibility for retransmission for a remaining number of CG configurations. In implementations in which a CG retransmission is disabled, the UE 115-a and the network entity 105-a may set a retransmission timer (e.g., one or more of a configured grant timer 220, a HARQ timer 225, and a DRX retransmission timer 230) to a zero value and may transition to a radio link control (RLC) unacknowledged mode (UM), if the UE 115-a and the network entity 105-a are not already in an RLC UM. As such, the UE 115-a and the network entity 105-a may avoid being in an RLC acknowledged mode (AM), which may result in a triggering of an RLC level retransmission, which may in turn trigger a new HARQ process start. Accordingly, the UE 115-a and the network entity 105-a may avoid any added latency associated with such an RLC level retransmission and a new HARQ process start by transitioning to an RLC UM based on disabling retransmission for a CG and setting a retransmission timer that is specific to the CG to a zero value.

In an example, the network entity 105-a may initially indicate a non-zero retransmission timer value for the CG 210 and may subsequently transmit an indication to the UE 115-a indicating that retransmission for data sent in accordance with the CG 210 is disabled. As such, the UE 115-a may set or update the value of the retransmission timer to a zero value (which may be understood as disabling the retransmission timer, such as disabling one or more of a configured grant timer 220, a HARQ timer 225, and a DRX retransmission timer 230) and refrain from monitoring a PDCCH 245 for a retransmission request for the data sent in accordance with the CG 210. Likewise, the network entity 105-a may set or update the value of the retransmission timer to a zero value (e.g., disable the retransmission timer) and refrain from transmitting a retransmission request for the data sent in accordance with the CG 210.

In some implementations, the network entity 105-a may configure separate values for a retransmission timer (e.g., one or more of a configured grant timer 220, a HARQ timer 225, and a DRX retransmission timer 230) directly with different CG configurations. In such implementations, the network entity 105-a may explicitly indicate which retransmission timer value corresponds to which CG via a set of one or more CG configurations. In some other implementations, the network entity 105-a may associate a logical channel with a retransmission timer value (e.g., a value for one or more of a configured grant timer 220, a HARQ timer 225, and a DRX retransmission timer 230) and the UE 115-a and the network entity 105-a may expect that any data message sent using a CG via a specific logical channel will be associated with a retransmission timer that is configured for the specific logical channel. In other words, the UE 115-a and the network entity 105-a may support a direct association between logical channel and retransmission timer value. As such, different logical channels may have or otherwise be associated with different retransmission timer values.

In an example, the network entity 105-a may configure a one-to-multiple mapping from CGs to logical channels (such that a given CG may be mapped or assigned to one of multiple different logical channels) and may configure the multiple logical channels with different retransmission timer values. The network entity 105-a may transmit signaling indicating to which logical channel a CG is mapped or assigned to indirectly associate the CG with a retransmission timer that is specific to the CG. Additionally, or alternatively, the UE 115-a and the network entity 105-a may support a mutually understood or pre-configured mapping or assignment rule according to which the UE 115-a and the network entity 105-a expect a CG carrying a specific traffic type to be mapped or assigned to a specific logical channel, where that specific logical channel is configured with a retransmission timer that is suitable for the specific traffic type. In the context of the wireless communications system 200, the UE 115-a and the network entity 105-a may map or assign the CG 210 to a first logical channel associated with a zero value retransmission timer and the UE 115-a and the network entity 105-a may map or assign the CG 215 to a second logical channel associated with a non-zero retransmission timer value.

Further, in some implementations, the UE 115-a and the network entity 105-a may support or allow simultaneous transmission of two or more CGs in a same slot in accordance with supporting a zero value retransmission timer for a CG. For example, if the UE 115-a transmits a first data message in accordance with the CG 210 (such that the UE 115-a and the network entity 105-a do not expect a retransmission of the first data message based on the CG 210 being associated with a zero value retransmission timer), the network entity 105-a may schedule the UE 115-a to transmit a second data message in accordance with the CG 215 in a same slot as the first data message transmitted in accordance with the first CG because the lack of a possibility for a retransmission of the first data message may preclude a scheduling conflict between a retransmission of the first data message and the transmission of the second data message. Additionally, or alternatively, the UE 115-a and the network entity 105-a may not expect (e.g., may not support or allow) simultaneous transmission of multiple CGs in a same slot if more than one of the multiple CGs are associated with non-zero retransmission timer values (e.g., because scheduling conflicts may arise based on a requested retransmission).

In some aspects, the UE 115-a and the network entity 105-a may further employ a frequency-related constraint associated with supporting simultaneous transmission of two or more CGs in a same slot. In some implementations, for example, the UE 115-a and the network entity 105-a may support or allow simultaneous transmission of two or more CGs in a same slot if the two or more CGs are configured contiguously in the frequency domain. Otherwise (e.g., if the two or more CGs are not configured contiguously in the frequency domain), the UE 115-a and the network entity 105-a may not expect (e.g., may not support or allow) the simultaneous transmission of the two or more CGs in the same slot.

In some scenarios, the UE 115-a may transmit a data message using a retransmission-less CG and otherwise be in an active time mode. In such scenarios, the UE 115-a may still monitor a PDCCH 245. As such, the UE 115-a may potentially receive DCI 240 indicating a retransmission request for the CG transmission (e.g., which has the same HARQ process ID and a new data indicator (NDI) field value of one). If such a DCI 240 requesting retransmission is received by the UE 115-a, the UE 115-a may identify or otherwise determine that the DCI 240 corresponds to a retransmission-less CG and ignore the DCI 240 based on the identification or determination. In other words, if the UE 115-a receives DCI 240 indicating a retransmission request for a retransmission-less CG, the UE 115-a may ignore the DCI 240.

Additionally, or alternatively, the UE 115-a and the network entity 105-a may support a UE-led indication on whether a retransmission timer is to be started. In some scenarios, for example, the UE 115-a may send data (e.g., relatively small data, such as pose information) using a CG and may also send a buffer status report (BSR) along with the data. The BSR may inform the network entity 105-a about a quantity or amount of data the UE 115-a is to transmit to the network entity 105-a. As such, upon receiving the BSR from the UE 115-a, the network entity 105-a may provide one or more uplink grants to serve the UE 115-a (e.g., to provide the UE 115-a with sufficient resources over which the UE 115-a may transmit its data to the network entity 105-a). In such cases in which the UE 115-a sends pose information and a BSR, the UE 115-a may monitor a PDCCH to receive one or more dynamic uplink grants from the network entity 105-a. However, if the UE 115-a sends pose information without a BSR, the UE 115-a may refrain from monitoring a PDCCH (e.g., no retransmission timer is required, which may improve power savings).

Accordingly, in some implementations, the UE 115-a and the network entity 105-a may support an explicit or implicit uplink UE indication of a retransmission timer start. In implementations in which the UE 115-a and the network entity 105-a support an explicit indication, in a CG transmission, the UE 115-a may include an indication (e.g., an uplink control indication for retransmission timer start, such as IND_RETX_START) to indicate whether the UE 115-a and the network entity 105-a are to start a retransmission timer or not. For example, if the explicit indication is a bit (e.g., a IND_RETX_START bit or field), a bit value of 1 may indicate that the UE 115-a and the network entity 105-a are to start one or more of drx-HARQ-RTT-TimerUL, drx-RetransmissionTimerUL, and configuredGrantTimer. In such examples, the UE 115-a may move a UE state or mode to Active Time in which the UE 115-a may monitor a PDCCH to receive one or more uplink grants from the network entity 105-a. For further example, a bit value of 0 may indicate that the UE 115-a and the network entity 105-a are to skip or refrain from starting one or more of drx-HARQ-RTT-TimerUL, drx-RetransmissionTimerUL, and configuredGrantTimer. In some aspects, the UE 115-a may transmit the explicit via uplink control information (UCI) multiplexed with or otherwise along with the data using a CG.

In implementations in which the UE 115-a and the network entity 105-a support an implicit indication, the UE 115-a and the network entity 105-a may determine whether to start a retransmission timer based on whether a BSR is transmitted by the UE 115-a in a CG transmission along with data. For example, if a CG transmission includes a BSR, the UE 115-a and the network entity 105-a may start one or more of drx-HARQ-RTT-TimerUL, drx-RetransmissionTimerUL, and configuredGrantTimer. In such examples, the UE 115-a may move a UE state or mode to Active Time (e.g., DRX Active Time) in which the UE 115-a may monitor a PDCCH to receive one or more uplink grants from the network entity 105-a. For further example, if a CG transmission does not include a BSR, the UE 115-a and the network entity 105-a may skip or refrain from starting one or more of drx-HARQ-RFI-TimerUL, drx-RetransmissionTimerUL, and configuredGrantTimer. In some aspects, the UE 115-a may include the BSR in UCI multiplexed with or otherwise transmitted along with the data using a CG.

In some implementations, the explicit or implicit indication, from the UE 115-a, of whether to start a retransmission timer may correspond to a retransmission timer that is specifically associated with a CG that the UE 115-a uses to transmit the explicit or implicit indication. Further, if a conflict arises between an explicit or implicit indication of whether to start a retransmission timer and a specific retransmission timer, the explicit or implicit indication of whether to start a retransmission timer may supersede the specific retransmission timer or the specific retransmission timer may supersede the explicit or implicit indication of whether to start a retransmission timer. For example, if the UE 115-a transmits an indication to start a retransmission timer but the retransmission timer that is specific to the CG used by the UE 115-a is associated with a zero value, the UE 115-a and the network entity 105-a may either determine and start a non-zero retransmission timer (if the indication supersedes) or determine to maintain a zero second monitoring duration 235 (if the specific retransmission timer supersedes).

Additionally, or alternatively, the UE 115-a and the network entity 105-a may support a dependent configuration associated with CGs for uplink transmissions. For example, the UE 115-a and the network entity 105-a may support a mapping rule that defines a correspondence between a first set of parameters associated with downlink communication from the network entity 105-a to the UE 115-a and a second set of parameters associated with uplink communication from the UE 115-a to the network entity 105-a. In some implementations, the UE 115-a may employ the mapping rule to align uplink CG transmissions with downlink activity. For example, the UE 115-a and the network entity 105-a may compute, select, ascertain, or otherwise determine an uplink periodicity associated with a CG based on a downlink periodicity associated with downlink communication. Such a downlink periodicity may refer to or be associated with one or both of a downlink DRX cycle or a downlink SPS periodicity and, as such, an uplink CG periodicity may follow a downlink DRX or SPS periodicity. Accordingly, if the UE 115-a and the network entity 105-a determine a downlink DRX start offset or downlink SPS occasions, the UE 115-a and the network entity 105-a may determine one or more uplink CG transmission occasions based on the DRX configuration or the SPS configuration.

In some implementations, the UE 115-a and the network entity 105-a may apply a scaling factor N to the DRX cycle or SPS periodicity to determine the uplink CG periodicity. For example, the UE 115-a and the network entity 105-a may scale the downlink periodicity such that the uplink CG periodicity follows the downlink DRX or SPS periodicity scaled by N. N may refer to one of various values. For example, N=1/2, 1/4, or 1/8. In some aspects, the network entity 105-a may indicate a value of N to the UE 115-a. In some aspects, the network entity 105-a may indicate the value of N to the UE 115-a based on assistance information provided to the network entity 105-a by the UE 115-a. In some other aspects, a value of N may be pre-configured (e.g., pre-loaded at the UE 115-a). Further, in some implementations, the UE 115-a and the network entity 105-a may perform a unit conversion or some translation of units in accordance with the mapping between the downlink periodicity and the uplink CG periodicity. For example, DRX cycle lengths and SPS periodicities may be defined, measured, or indicated in units of milliseconds while CG periodicities may be defined, measured, or indicated in units of symbols. As such, the UE 115-a and the network entity 105-a may perform a unit conversion from milliseconds to symbols as part of determining an uplink CG periodicity based on a downlink DRX cycle length or a downlink SPS periodicity.

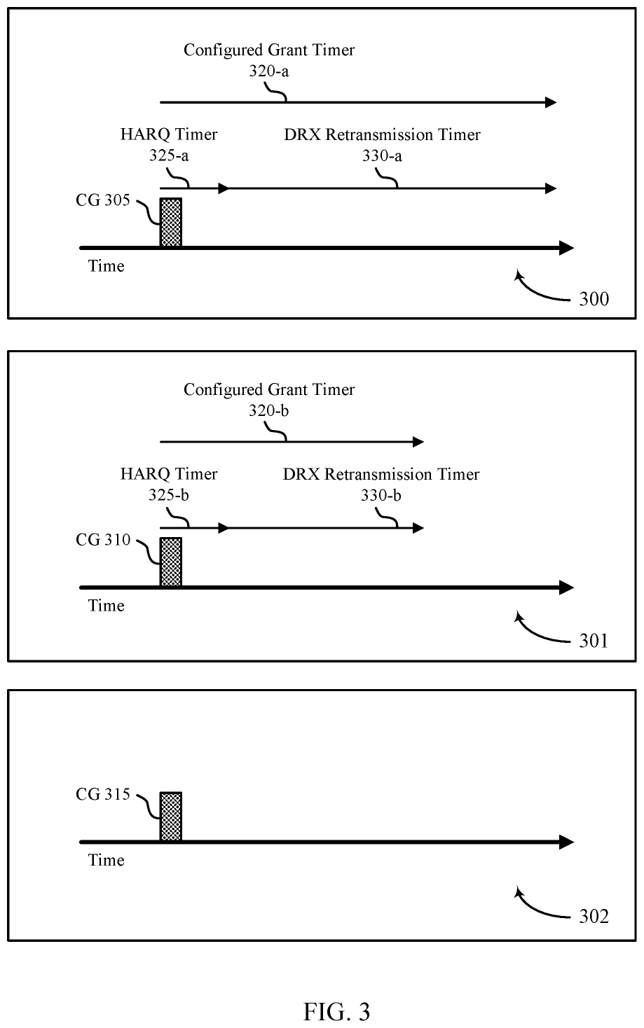

FIG. 3 shows examples of CG-specific retransmission timer configurations 300, 301, and 302 that support CG enhancements for XR uplink traffic in accordance with one or more aspects of the present disclosure. The CG-specific retransmission timer configurations 300, 301, and 302 may implement or be implemented to realize aspects of the wireless communications system 100 or the wireless communications system 200. For example, a UE 115 and a network entity 105, which may be examples of corresponding devices as illustrated by and described with reference to FIGS. 1 and 2, may support the CG-specific retransmission timer configurations 300, 301, and 302 in accordance with an uplink traffic type to be communicated using various different CGs. For example, the UE 115 and the network entity 105 may support a CG 305, a CG 310, and a CG 315 and may further support different retransmission timer configurations for each of the CG 305, the CG 310, and the CG 315 in accordance with an uplink traffic type to be communicated using each CG.

As illustrated by the CG-specific retransmission timer configuration 300, the UE 115 and the network entity 105 may support a configured grant timer 320-a, a HARQ timer 325-a, and a DRX retransmission timer 330-a for the CG 305. For example, the UE 115 may be scheduled to transmit a first data message associated with a relatively non-low-latency traffic type (e.g., scene information in an XR application) using the CG 305 and, as such, the UE 115 and the network entity 105 may support a relatively longer retransmission timer (e.g., one or more of the configured grant timer 320-a, the HARQ timer 325-a, or the DRX retransmission timer 330-a) based on the first data message being associated with the relatively non-low-latency traffic type. In some aspects, the DRX retransmission timer 330-a may be set to 10 milliseconds if the first data message is associated with scene information in an XR application.

As illustrated by the CG-specific retransmission timer configuration 301, the UE 115 and the network entity 105 may support a configured grant timer 320-b, a HARQ timer 325-b, and a DRX retransmission timer 330-b for the CG 310. For example, the UE 115 may be scheduled to transmit a second data message associated with a relatively lower-latency traffic type using the CG 310 and, as such, the UE 115 and the network entity 105 may support a relatively shorter retransmission timer (e.g., one or more of the configured grant timer 320-b, the HARQ timer 325-b, or the DRX retransmission timer 330-b) based on the second data message being associated with the relatively lower-latency traffic type. In some aspects, the configured grant timer 320-b, the HARQ timer 325-b, and the DRX retransmission timer 330-b may be shorter than the configured grant timer 320-a, the HARQ timer 325-a, and the DRX retransmission timer 330-a, respectively, based on the second data message being associated with relatively lower latency traffic than the first data message.

As illustrated by the CG-specific retransmission timer configuration 302, the UE 115 and the network entity 105 may support a zero value for a retransmission timer for the CG 315. For example, the UE 115 may be scheduled to transmit a third data message associated with a low-latency traffic type (e.g., pose information in an XR application) using the CG 315 and, as such, the UE 115 and the network entity 105 may disable retransmission for the third data message by configuring a zero value for a retransmission timer for the CG 315 based on the third data message being associated with the low-latency traffic type (which may be understood as disabling the retransmission timer for the CG 315). In some aspects, a DRX retransmission timer for the CG 315 may be set to 0 milliseconds if the third data message is associated with pose information in an XR application and, likewise, a retransmission timer for the CG 315 is not shown.

Further, although illustrated in the context of FIG. 3 as being equal to a summation of a HARQ timer 325 and a DRX retransmission timer 330, a configured grant timer 320 may be any value indicated by the network entity 105 and may be separate or distinct from a HARQ timer 325 and a DRX retransmission timer 330. Alternatively, although potentially indicated by the network entity 105 separately (e.g., via a separate parameter), a configured grant timer 320 may be tied or related to a HARQ timer 325 and a DRX retransmission timer 330 such that the UE 115 assumes an ACK for a data message at the same time the UE 115 stops monitoring for a retransmission request for the data message.

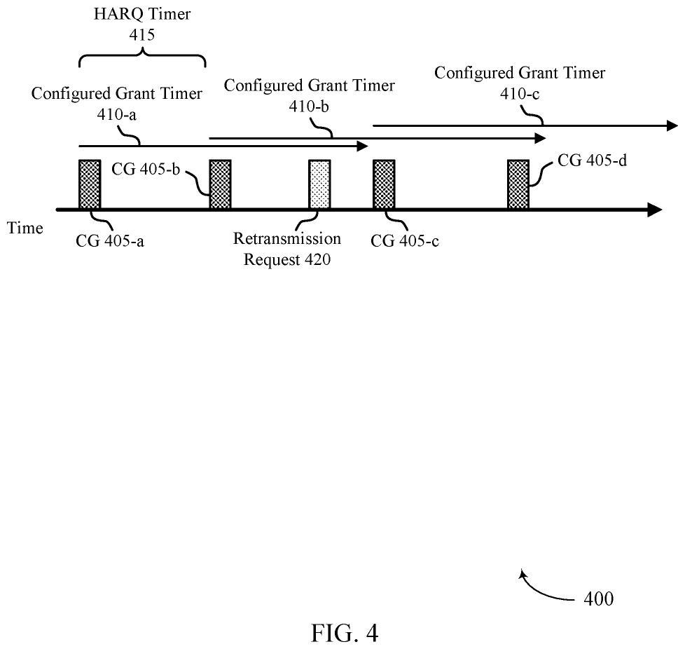

FIG. 4 shows an example of a communication timeline 400 that supports CG enhancements for XR uplink traffic in accordance with one or more aspects of the present disclosure. The communication timeline 400 may implement or be implemented to realize aspects of the wireless communications system 100, the wireless communications system 200, or the CG-specific retransmission timer configurations 300, 301, and 302. For example, a UE 115 and a network entity 105, which may be examples of corresponding devices as illustrated by and described with reference to FIGS. 1 and 2, may communicate in accordance with the communication timeline 400. In some implementations, the UE 115 and the network entity 105 may support CG-specific retransmission timers such that a configured grant timer 410 associated with a CG 405 may depend on an uplink traffic type to be communicated in accordance with the CG 405. As described in the context of FIG. 4, a CG 405 may generally refer to any one or more of a CG 405-a, a CG 405-b, a CG 405-c, and a CG 405-d and a configured grant timer 410 may generally refer to any one or more of a configured grant timer 410-a, a configured grant timer 410-b, and a configured grant timer 410-c.

As illustrated by the communication timeline 400, the UE 115 may transmit a first data message using a CG 405-a and may start a configured grant timer 410-a when the UE 115 transmits the data message using the CG 405-a. Further, the UE 115 may start a HARQ timer 415 when the UE 115 transmits the first data message using the CG 405-a. In some aspects, the first data message or the CG 405-a may be associated with a HARQ process ID=1 and the UE 115 or the network entity 105, or both, may avoid using HARQ process ID=1 during a time period defined by or associated with the HARQ timer 415. The UE 115 may transmit a second data message using the CG 405-b and, upon transmitting the second data message using the CG 405-b, the UE 115 may start a configured grant timer 410-b. The second data message or the CG 405-b may be associated with a HARQ process ID=2.

In some scenarios, the network entity 105 may transmit, to the UE 115, a retransmission request 420 for the first data message (sent in accordance with the CG 405-a) via DCI and, in such scenarios, the UE 115 may perform a retransmission of the first data message using a CG 405-c. Accordingly, the first data message or the CG 405-c may be associated with a HARQ process ID=1. The UE 115 may start a configured grant timer 410-c upon retransmitting the first data message using the CG 405-c. Further, the UE 115 may transmit a third data message using a CG 405-d and, upon transmitting the third data message using the CG 405-d, may start another configured grant timer associated with the CG 405-d. In some aspects, the third data message or the CG 405-d may be associated with a HARQ process ID=3.

FIG. 5 shows an example of a communication timeline 500 that supports CG enhancements for XR uplink traffic in accordance with one or more aspects of the present disclosure. The communication timeline 500 may implement or be implemented to realize aspects of the wireless communications system 100, the wireless communications system 200, the CG-specific retransmission timer configurations 300, 301, and 302, or the communication timeline 400. For example, a UE 115 and a network entity 105, which may be examples of corresponding devices as illustrated by and described with reference to FIGS. 1 and 2, may communicate in accordance with the communication timeline 500 in accordance with a deployment associated with an XR application associated with a transmission of one or more bursts of file arrivals 505 and a frame generation periodicity 510.

For example, the UE 115 and the network entity 105 may support an XR application and may communicate XR downlink traffic and XR uplink traffic. XR traffic may include periodic transmission of video frames. As referred to herein, an XR application may include one or both of a VR application or an AR application and may be associated with various traffic flows and XR frame rates. The XR application may support, for example, a 60 Hz or a 120 Hz frame rate. In deployments in which the XR application supports a 60 Hz frame rate, the XR application may be associated with a frame generation periodicity 510 of approximately 16.67 milliseconds. In deployments in which the XR application supports a 120 Hz frame rate, the XR application may be associated with a frame generation periodicity 510 of approximately 8.33 milliseconds.

In the context of XR downlink traffic arrival, an XR frame may be generated periodically. Further, an XR frame may be divided into multiple slices and each of the multiple slices may be encoded separately. An encoded slide (which may be equivalently referred to herein as a file 515) may be sent from an XR server to the network entity 105 (e.g., a gNB). The slices may be sent over the air through multiple transport blocks (TBs) (e.g., through a burst of TBs) and each burst may be associated with a transmission delay constraint. Further, and as illustrated by the differently sized arrows associated with a burst of file arrivals 505, the UE 115 may receive the files 515 or slices in a burst at slightly different times.

In the context of XR uplink data, the uplink traffic flow may depend on a specific application at the UE 115. For VR uplink data, for example, the UE 115 and the network entity 105 may support one uplink flow associated with pose information (which may provide information associated with six degrees of freedom associated with a user's motion or location) and control information. The data rate may be between approximately 0.5 megabits per second (Mbps) and approximately 2 Mbps. A transmission periodicity of pose information may be approximately 4 milliseconds (which may be associated with a frequency of 250 Hz) and a file size of the flow may be between approximately 125 bytes (e.g., 0.5 Mbps/500=1 kilobit=125 bytes) and approximately 500 bytes (e.g., 2 Mbps/500=4 kilobits=500 bytes). A PDB may be between approximately 1.25 milliseconds and approximately 10 milliseconds.

For AR uplink data, the UE 115 and the network entity 105 may support two uplink flows including a first flow associated with pose information (which may provide information associated with six degrees of freedom associated with a user's motion or location) and control information and a second flow associated with scene update information. The first flow associated with pose and control information may be associated with a data rate of between approximately 0.2 Mbps and approximately 2 Mbps, a pose information transmission periodicity of approximately 4 milliseconds (which may be associated with a frequency of 250 Hz), and a frame delay budget (FDB) of between approximately 1.25 milliseconds and approximately 10 milliseconds. The second flow associated with the scene update information may be associated with a data rate of approximately 10 Mbps at 10 Hz, a file size of approximately 1 megabit per 100 milliseconds (which may correspond to 125 kilobytes), and a packet delay budget of 100 milliseconds.

In some aspects, a pose information transmission may be relatively poorly suited for retransmission. For example, for a pose information transmission, a retransmission may not be helpful or practical because pose is associated with a relatively low packet delay budget (e.g., approximately 1 millisecond or approximately 10 milliseconds), stale pose information may not be useful for rendering a new frame, and new pose information may be available before a retransmission could actually occur. As such, the UE 115 may have less motivation for retransmitting pose information and the network entity 105 may likewise have less motivation or reason for requesting a retransmission of pose information. Further, and as described herein (including with reference to FIG. 2), running a retransmission timer associated with an uplink transmission increases UE power consumption. As such, in some implementations, the UE 115 and the network entity 105 may support a retransmission-less CG transmission in scenarios in which the UE 115 is to send low-latency traffic (e.g., pose information) using a CG. As described herein, the UE 115 and the network entity 105 may support a retransmission-less CG transmission in accordance with indicting a zero value for a retransmission timer that is specifically associated with that CG, by disabling retransmissions for that CG via another signaling indication, or by configuring a logical channel with a zero value for a retransmission timer and mapping that CG to the logical channel configured with the zero value for the retransmission timer.

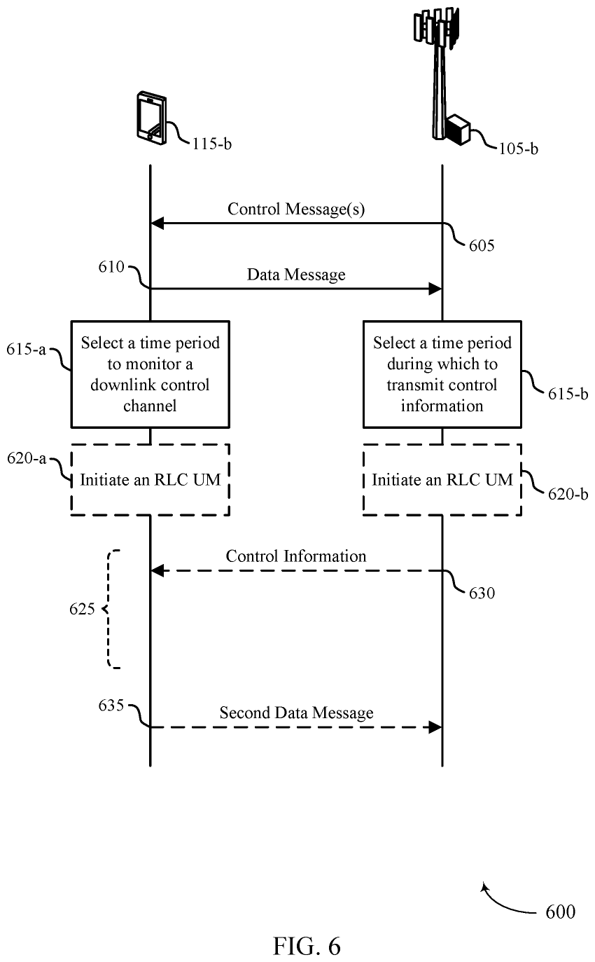

FIG. 6 shows an example of a process flow 600 that supports CG enhancements for XR uplink traffic in accordance with one or more aspects of the present disclosure. The process flow 600 may implement or be implemented by aspects of the wireless communications system 100, the wireless communications system 200, the CG-specific retransmission timer configurations 300, 301, and 302, the communication timeline 400, or the communication timeline 500. For example, the process flow 600 illustrates communication between a UE 115-b and a network entity 105-b, which may be examples of corresponding devices as illustrated by and described with reference to FIGS. 1 and 2. In some implementations, the UE 115-b and the network entity 105-b may support an association of a CG configuration and a retransmission timer. In other words, for example, the UE 115-b and the network entity 105-b may support a specific retransmission timer value for a CG based on an uplink traffic type to be communicated on the CG.

In the following description of the process flow 600, the operations may be performed (such as reported or provided) in a different order than the order shown, or the operations performed by the example devices may be performed in different orders or at different times. Some operations also may be left out of the process flow 600, or other operations may be added to the process flow 600. Further, although some operations or signaling may be shown to occur at different times for discussion purposes, these operations may actually occur at the same time.

At 605, the UE 115-b may receive, via one or more control messages from the network entity 105-b, an indication of a CG for uplink transmissions and a retransmission timer that is specific to the CG. In some aspects, the network entity 105-b may indicate the retransmission timer that is specific to the CG based on including an indication of the retransmission timer in a configuration of the CG, based on transmitting an indication to enable or disable retransmission for the CG that is specific to the CG (e.g., an indication to enable or disable one or more retransmission timers that are specific to the CG), or based on transmitting an indication that the CG is mapped to a logical channel that is configured with the retransmission timer.

At 610, the UE 115-b may transmit, to the network entity 105-b, a data message in accordance with the CG. For example, the UE 115-b may transmit the data message using a preconfigured time-frequency resource corresponding to the CG. The UE 115-b may start the retransmission timer, if the retransmission timer is associated with a non-zero value, based on transmitting the data message in accordance with the CG.

At 615-a, the UE 115-b may select a time period to monitor a downlink control channel (e.g., a PDCCH) for control information (e.g., DCI) associated with scheduling a retransmission of the data message in accordance with the retransmission timer that is specific to the CG. In some implementations, the UE 115-b may monitor the downlink control channel in accordance with the retransmission timer indicating a non-zero value. In such implementations, the UE 115-b may monitor the downlink control channel in accordance with the retransmission timer indicating a non-zero value based on the data message being associated with a non-low-latency traffic type (e.g., scene information in an XR application). In some other implementations, the UE 115-b may select not to monitor the downlink control channel in accordance with the retransmission timer indicating a zero value. In such implementations, the UE 115-b may select not to monitor the downlink control channel in accordance with the retransmission timer indicating the zero value based on the data message being associated with a low-latency traffic type (e.g., pose information in an XR application).

At 615-b, the network entity 105-b may select a time period during which to transmit control information (e.g., DCI) associated with scheduling a retransmission of the data message in accordance with the retransmission timer that is specific to the configured grant. In implementations in which the retransmission timer indicates a non-zero value, the network entity 105-b may select a non-zero timer period during which to potentially transmit control information indicating a retransmission request for the data message. Alternatively, in implementations in which the retransmission timer indicates a zero value, the network entity 105-b may select a time period of zero milliseconds and, as such, may select not to transmit the control information indicating the retransmission request for the data message.

At 620-a and 620-b, the UE 115-b and the network entity 105-b, respectively, may initiate an RLC UM in accordance with an indication to disable retransmission for the CG. In some implementations, for example, the network entity 105-b may transmit an indication to disable retransmission for the CG, the UE 115-b and the network entity 105-b may set the retransmission timer that is specific to the CG to a zero value (e.g., may overwrite a previous value of the retransmission timer) based on the disablement, and may initiate the RLC UM in accordance with setting the retransmission timer to the zero value.

In implementations in which the UE 115-b selects to monitor the downlink control channel, the UE 115-b may monitor the downlink control channel (e.g., PDCCH) for control information associated with requesting a retransmission of the data message for a time period 625, where the time period 625 is a non-zero duration. In such implementations, at 630, the UE 115-b may receive the control information associated with requesting a retransmission of the data message in accordance with monitoring the downlink control channel for the time period 625. The UE 115-b may retransmit the data message accordingly.

In implementations in which the UE 115-b selects not to monitor the downlink control channel (such that the time period 625 is zero milliseconds) for a retransmission request associated with the data message but is in an active time mode, still monitors the downlink control channel, and receives control information indicating a retransmission request for the data message, the UE 115-b may ignore the control information in accordance with the retransmission timer that is specific to the CG indicating a zero value.

At 635, the UE 115-b may, in some implementations, transmit a second data message in accordance with a second CG during a same slot as the data message and the CG based on the retransmission timer that is specific to the CG indicating a zero value. For example, if the retransmission timer that is specific to the CG indicates a zero value (such that the time period 625 is zero milliseconds), the network entity 105-b may schedule the UE 115-b for simultaneous transmission of two or more CGs in a same slot as a possibility of a scheduling conflict may be precluded by the zero value of the retransmission timer that is specific to the CG.

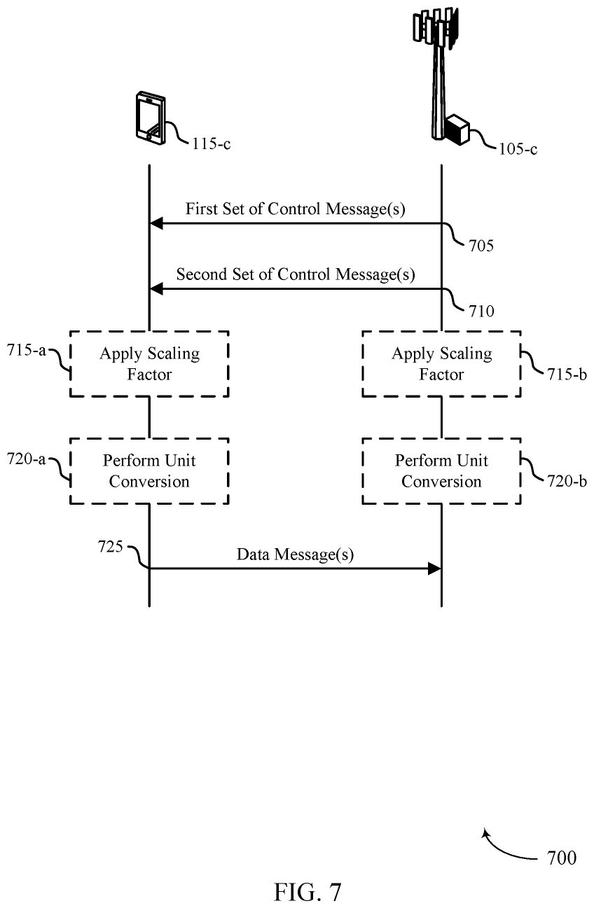

FIG. 7 shows an example of a process flow 700 that supports CG enhancements for XR uplink traffic in accordance with one or more aspects of the present disclosure. The process flow 700 may implement or be implemented by aspects of the wireless communications system 100 or the wireless communications system 200. For example, the process flow 700 illustrates communication between a UE 115-c and a network entity 105-c, which may be examples of corresponding devices as illustrated by and described with reference to FIGS. 1 and 2. In some implementations, the UE 115-c and the network entity 105-c may support a configuration dependency between one or more downlink parameters (e.g., a downlink periodicity) and one or more uplink parameters (e.g., an uplink periodicity).

In the following description of the process flow 700, the operations may be performed (such as reported or provided) in a different order than the order shown, or the operations performed by the example devices may be performed in different orders or at different times. Some operations also may be left out of the process flow 700, or other operations may be added to the process flow 700. Further, although some operations or signaling may be shown to occur at different times for discussion purposes, these operations may actually occur at the same time.

At 705, the UE 115-c may receive, via a first set of one or more control messages from the network entity 105-c, a first set of parameters associated with downlink communication from the network entity 105-c to the UE 115-c. In some aspects, the first set of parameters may include an indication of a downlink periodicity associated with the downlink communication, wherein the downlink periodicity may be associated with a DRX cycle or an SPS periodicity.

At 710, the UE 115-c may receive, via a second set of one or more control messages from the network entity 105-c, an indication of a set of resources for a CG for uplink transmissions. For example, the network entity 105-c may provide the UE 115-c with an indication of a preconfigured time-frequency resource that the UE 115-c may use for one or more uplink transmissions to the network entity 105-c.

At 715-a, the UE 115-c may apply a scaling factor to the downlink periodicity to obtain an uplink periodicity associated with the CG for the uplink transmissions. At 715-b, the network entity 105-c may similarly apply the scaling factor to the downlink periodicity to obtain the uplink periodicity associated with the CG for the uplink transmissions. For example, the uplink periodicity associated with the CG for the uplink transmissions may be equal to (after a unit conversion) or based on a product of the downlink periodicity and a scaling factor.

At 720-a, the UE 115-c may perform a unit conversion from milliseconds to symbols based on the downlink periodicity being defined by milliseconds and the uplink periodicity being defined by symbols to determine the uplink periodicity. At 720-b, the network entity 105-c may similarly perform the unit conversion from milliseconds to symbols based on the downlink periodicity being defined by milliseconds and the uplink periodicity being defined by symbols to determine the uplink periodicity.

At 725, the UE 115-c may transmit, to the network entity 105-c over the set of resources, one or more data messages in accordance with the CG using a second set of parameters that are associated with the first set of parameters associated with the downlink communication from the network entity 105-c to the UE 115-c. In some aspects, the second set of parameters may include the uplink periodicity that is associated with the downlink periodicity.

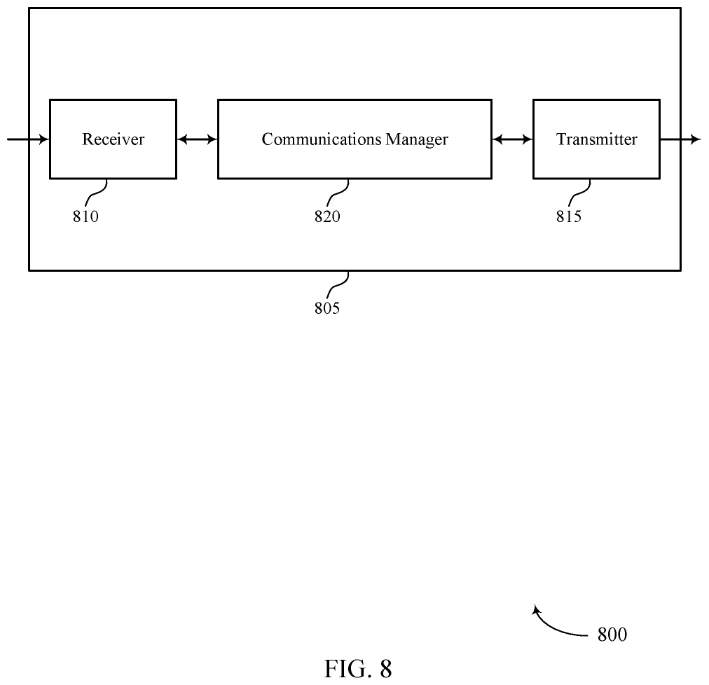

FIG. 8 shows a block diagram 800 of a device 805 that supports CG enhancements for XR uplink traffic in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to CG enhancements for XR uplink traffic). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to CG enhancements for XR uplink traffic). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of CG enhancements for XR uplink traffic as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for receiving, via one or more control messages, an indication of a CG for uplink transmissions and a retransmission timer that is specific to the CG. The communications manager 820 may be configured as or otherwise support a means for transmitting a data message in accordance with the CG. The communications manager 820 may be configured as or otherwise support a means for selecting a time period to monitor a downlink control channel for control information associated with scheduling a retransmission of the data message in accordance with the retransmission timer that is specific to the CG.

Additionally, or alternatively, the communications manager 820 may support wireless communication at a UE in accordance with examples as disclosed herein. For example, the communications manager 820 may be configured as or otherwise support a means for receiving, via a first set of one or more control messages, a first set of parameters associated with downlink communication from a network entity to the UE. The communications manager 820 may be configured as or otherwise support a means for receiving, via a second set of one or more control messages, an indication of a set of resources for a CG for uplink transmissions. The communications manager 820 may be configured as or otherwise support a means for transmitting, over the set of resources, one or more data messages in accordance with the CG using a second set of parameters that are associated with the first set of parameters associated with the downlink communication from the network entity to the UE.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources.

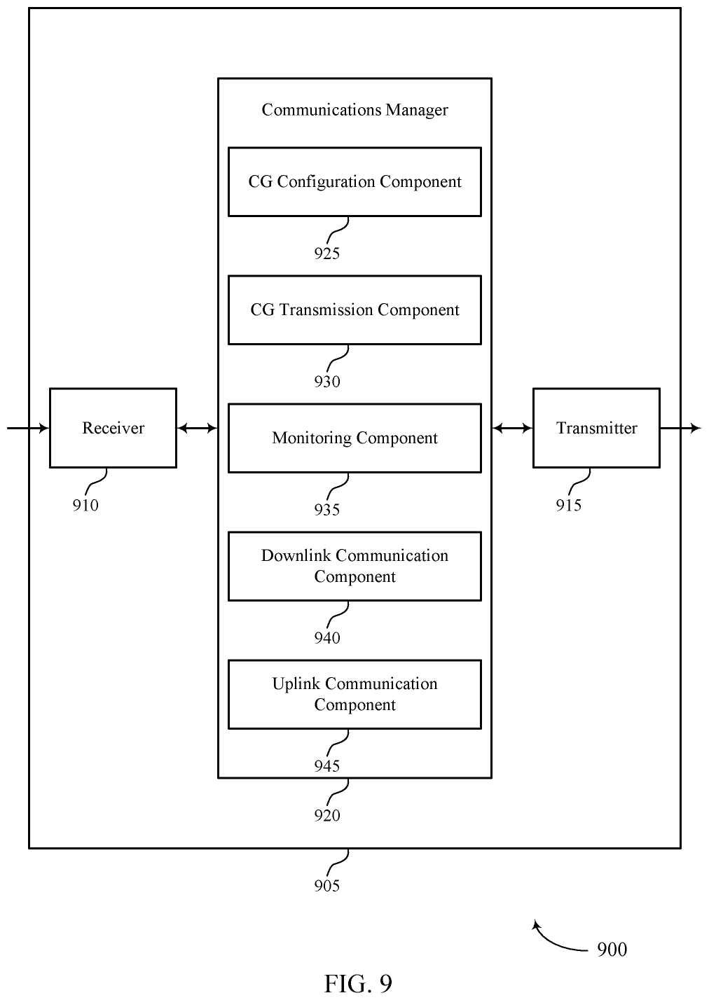

FIG. 9 shows a block diagram 900 of a device 905 that supports CG enhancements for XR uplink traffic in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to CG enhancements for XR uplink traffic). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to CG enhancements for XR uplink traffic). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of CG enhancements for XR uplink traffic as described herein. For example, the communications manager 920 may include a CG configuration component 925, a CG transmission component 930, a monitoring component 935, a downlink communication component 940, an uplink communication component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The CG configuration component 925 may be configured as or otherwise support a means for receiving, via one or more control messages, an indication of a CG for uplink transmissions and a retransmission timer that is specific to the CG. The CG transmission component 930 may be configured as or otherwise support a means for transmitting a data message in accordance with the CG. The monitoring component 935 may be configured as or otherwise support a means for selecting a time period to monitor a downlink control channel for control information associated with scheduling a retransmission of the data message in accordance with the retransmission timer that is specific to the CG.

Additionally, or alternatively, the communications manager 920 may support wireless communication at a UE in accordance with examples as disclosed herein. The downlink communication component 940 may be configured as or otherwise support a means for receiving, via a first set of one or more control messages, a first set of parameters associated with downlink communication from a network entity to the UE. The CG configuration component 925 may be configured as or otherwise support a means for receiving, via a second set of one or more control messages, an indication of a set of resources for a CG for uplink transmissions. The uplink communication component 945 may be configured as or otherwise support a means for transmitting, over the set of resources, one or more data messages in accordance with the CG using a second set of parameters that are associated with the first set of parameters associated with the downlink communication from the network entity to the UE.

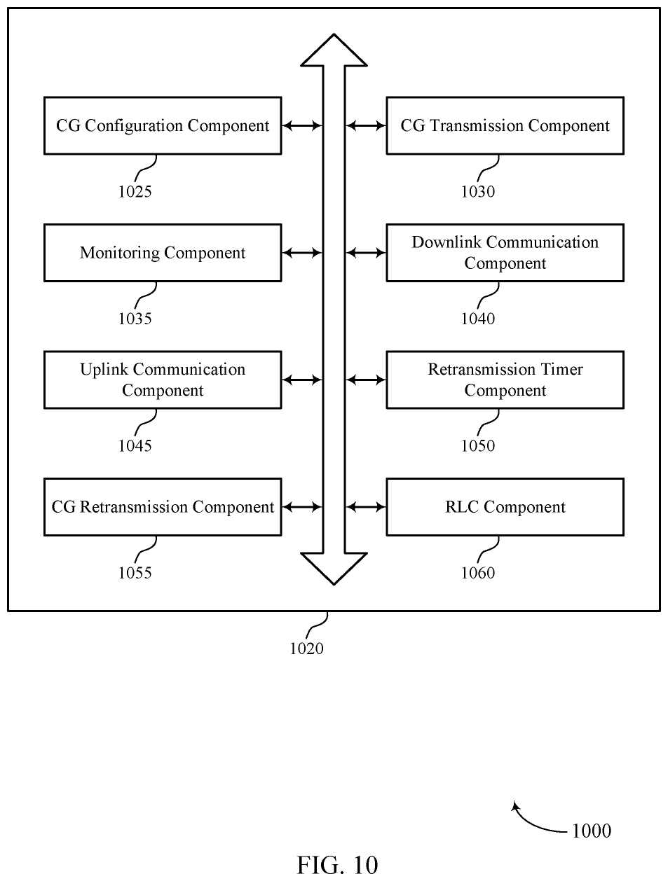

FIG. 10 shows a block diagram 1000 of a communications manager 1020 that supports CG enhancements for XR uplink traffic in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of CG enhancements for XR uplink traffic as described herein. For example, the communications manager 1020 may include a CG configuration component 1025, a CG transmission component 1030, a monitoring component 1035, a downlink communication component 1040, an uplink communication component 1045, a retransmission timer component 1050, a CG retransmission component 1055, an RLC component 1060, or any combination thereof. Each of these components may communicate, directly or indirectly, with one another (e.g., via one or more buses).

The communications manager 1020 may support wireless communication at a UE in accordance with examples as disclosed herein. The CG configuration component 1025 may be configured as or otherwise support a means for receiving, via one or more control messages, an indication of a CG for uplink transmissions and a retransmission timer that is specific to the CG. The CG transmission component 1030 may be configured as or otherwise support a means for transmitting a data message in accordance with the CG. The monitoring component 1035 may be configured as or otherwise support a means for selecting a time period to monitor a downlink control channel for control information associated with scheduling a retransmission of the data message in accordance with the retransmission timer that is specific to the CG.

In some examples, the monitoring component 1035 may be configured as or otherwise support a means for monitoring the downlink control channel for the control information in accordance with the retransmission timer indicating a non-zero value.

In some examples, the retransmission timer that is specific to the CG indicates the non-zero value based on the data message to be communicated on the CG being associated with a non-low-latency traffic type. In some examples, the time period is equal to a non-zero quantity of milliseconds in accordance with the retransmission timer indicating the non-zero value.

In some examples, to support selecting the time period to monitor the downlink control channel for the control information, the monitoring component 1035 may be configured as or otherwise support a means for selecting not to monitor the downlink control channel for the control information in accordance with the retransmission timer indicating a zero value.

In some examples, the retransmission timer that is specific to the CG indicates the zero value based on the data message to be communicated on the CG being associated with a low-latency traffic type. In some examples, the time period is equal to zero milliseconds in accordance with the retransmission timer indicating the zero value.

In some examples, to support receiving the one or more control messages, the CG configuration component 1025 may be configured as or otherwise support a means for receiving an indication to disable retransmission for the CG, where the indication to disable retransmission is specific to the CG. In some examples, to support receiving the one or more control messages, the retransmission timer component 1050 may be configured as or otherwise support a means for setting the retransmission timer to a zero value in accordance with the indication to disable retransmission for the CG, where selecting the time period to monitor the downlink control channel is further in accordance with setting the retransmission timer to the zero value.

In some examples, to support setting the retransmission timer to the zero value, the CG configuration component 1025 may be configured as or otherwise support a means for disabling the retransmission timer. In some examples, to support disabling the retransmission timer, the CG configuration component 1025 may be configured as or otherwise support a means for disabling one or more of a set of retransmission timers associated with the retransmission timer, where the set of retransmission timers includes one or more of a CG timer, a HARQ timer, or an uplink DRX retransmission timer.

In some examples, the RLC component 1060 may be configured as or otherwise support a means for initiating a radio link control unacknowledged mode at the UE in accordance with receiving the indication to disable retransmission for the CG.

In some examples, the CG transmission component 1030 may be configured as or otherwise support a means for transmitting, with the data message and in accordance with the configured grant, an indication of whether to start the retransmission timer, where selecting the time period to monitor the downlink control channel is further in accordance with the indication of whether to start the retransmission timer.

In some examples, the indication is a bit transmitted with the data message. In some examples, a bit value of 1 indicates that the retransmission timer is to be started. In some examples, a bit value of 0 indicates that the retransmission timer is not to be started. In some examples, selecting the time period is associated with whether the retransmission is to be started.

In some examples, the CG transmission component 1030 may be configured as or otherwise support a means for transmitting, with the data message and in accordance with the configured grant, a BSR, where selecting the time period to monitor the downlink control channel is further in accordance with the BSR being transmitted with the data message.

In some examples, a transmission of the BSR with the data message indicates that the retransmission timer is to be started. In some examples, an absence of the BSR with the data message indicates that the retransmission timer is not to be started. In some examples, selecting the time period is associated with whether the retransmission is to be started.

In some examples, the retransmission timer is specific to a logical channel over which the UE transmits the data message. In some examples, the CG is mapped to the logical channel in accordance with a traffic type of the data message to be communicated on the CG.

In some examples, the CG transmission component 1030 may be configured as or otherwise support a means for transmitting a second data message in accordance with a second CG during a same slot as the data message and the CG based on the retransmission timer that is specific to the CG indicating a zero value.

In some examples, the second data message and the data message can be transmitted during the same slot if the CG and the second CG are contiguous in a frequency domain.

In some examples, the CG retransmission component 1055 may be configured as or otherwise support a means for receiving the control information associated with scheduling the retransmission of the data message. In some examples, the CG retransmission component 1055 may be configured as or otherwise support a means for ignoring the control information in accordance with the retransmission timer that is specific to the CG indicating a zero value.

In some examples, the retransmission timer indicates a relatively smaller value if the data message is associated with a low-latency traffic type and indicates a relatively larger value if the data message is associated with a non-low-latency traffic type.

In some examples, the retransmission timer is a CG timer parameter or an uplink DRX retransmission timer parameter.

Additionally, or alternatively, the communications manager 1020 may support wireless communication at a UE in accordance with examples as disclosed herein. The downlink communication component 1040 may be configured as or otherwise support a means for receiving, via a first set of one or more control messages, a first set of parameters associated with downlink communication from a network entity to the UE. In some examples, the CG configuration component 1025 may be configured as or otherwise support a means for receiving, via a second set of one or more control messages, an indication of a set of resources for a CG for uplink transmissions. The uplink communication component 1045 may be configured as or otherwise support a means for transmitting, over the set of resources, one or more data messages in accordance with the CG using a second set of parameters that are associated with the first set of parameters associated with the downlink communication from the network entity to the UE.

In some examples, receiving the first set of parameters associated with the downlink communication includes. In some examples, receiving an indication of a downlink periodicity associated with the downlink communication. In some examples, transmitting the one or more data messages in accordance with the CG using the second set of parameters includes. In some examples, transmitting the one or more data messages in accordance with an uplink periodicity that is associated with the downlink periodicity.

In some examples, the uplink periodicity is equal to a product of the downlink periodicity and a scaling factor.

In some examples, the uplink communication component 1045 may be configured as or otherwise support a means for determining the uplink periodicity in accordance with a unit conversion from milliseconds to symbols based on the downlink periodicity being defined by milliseconds and the uplink periodicity being defined by symbols.

In some examples, the downlink periodicity is associated with a DRX cycle or an SPS periodicity.

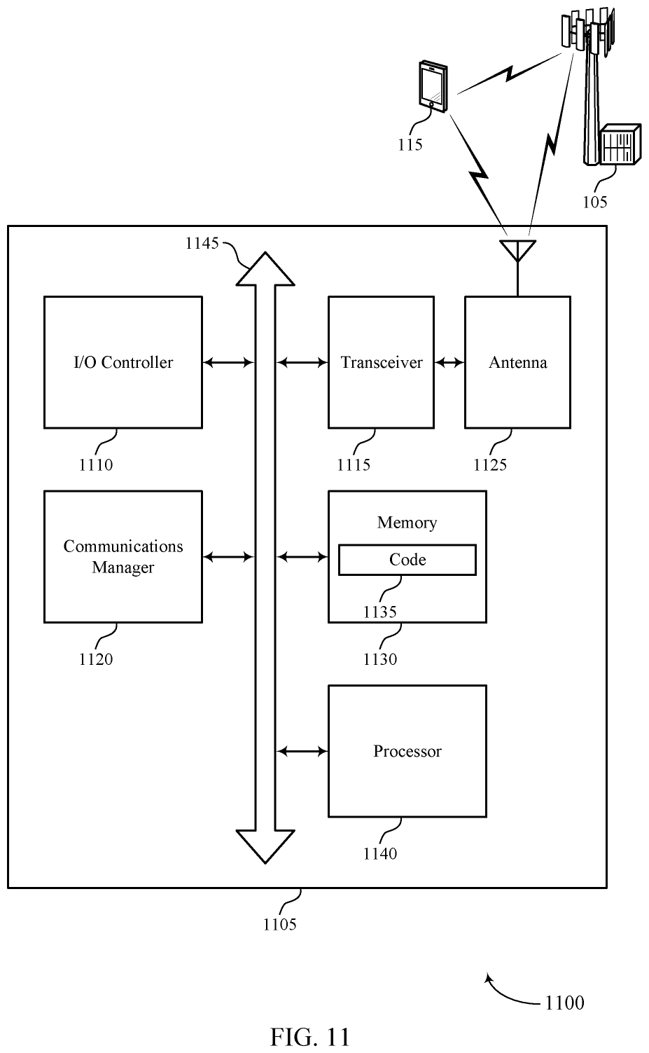

FIG. 11 shows a diagram of a system 1100 including a device 1105 that supports CG enhancements for XR uplink traffic in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting CG enhancements for XR uplink traffic). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving, via one or more control messages, an indication of a CG for uplink transmissions and a retransmission timer that is specific to the CG. The communications manager 1120 may be configured as or otherwise support a means for transmitting a data message in accordance with the CG. The communications manager 1120 may be configured as or otherwise support a means for selecting a time period to monitor a downlink control channel for control information associated with scheduling a retransmission of the data message in accordance with the retransmission timer that is specific to the CG.

Additionally, or alternatively, the communications manager 1120 may support wireless communication at a UE in accordance with examples as disclosed herein. For example, the communications manager 1120 may be configured as or otherwise support a means for receiving, via a first set of one or more control messages, a first set of parameters associated with downlink communication from a network entity to the UE. The communications manager 1120 may be configured as or otherwise support a means for receiving, via a second set of one or more control messages, an indication of a set of resources for a CG for uplink transmissions. The communications manager 1120 may be configured as or otherwise support a means for transmitting, over the set of resources, one or more data messages in accordance with the CG using a second set of parameters that are associated with the first set of parameters associated with the downlink communication from the network entity to the UE.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of CG enhancements for XR uplink traffic as described herein, or the processor 1140 and the memory 1130 may be otherwise configured to perform or support such operations.

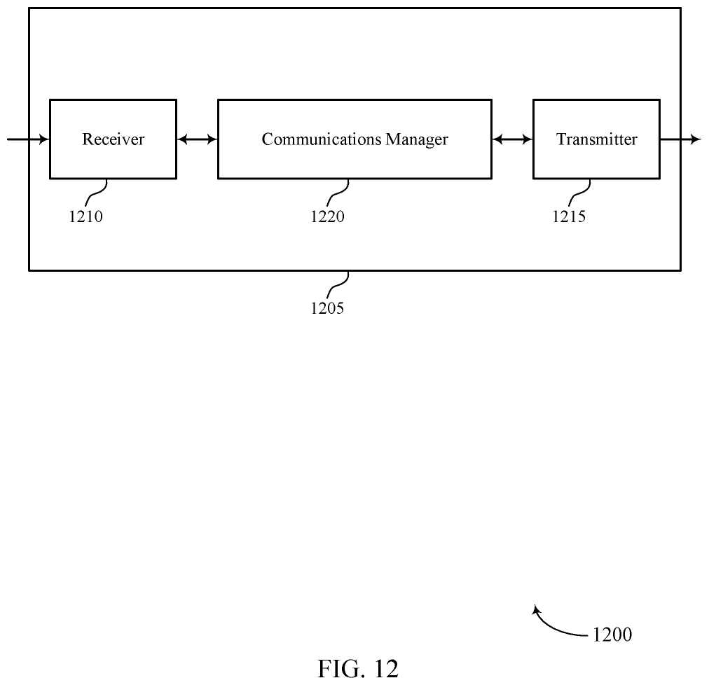

FIG. 12 shows a block diagram 1200 of a device 1205 that supports CG enhancements for XR uplink traffic in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of CG enhancements for XR uplink traffic as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and memory coupled with the at least one processor may be configured to perform one or more of the functions described herein (e.g., by executing, by the at least one processor, instructions stored in the memory).

Additionally, or alternatively, in some examples, the communications manager 1220, the receiver 1210, the transmitter 1215, or various combinations or components thereof may be implemented in code (e.g., as communications management software) executed by a processor. If implemented in code executed by a processor, the functions of the communications manager 1220, the receiver 1210, the transmitter 1215, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 may be configured as or otherwise support a means for transmitting, via one or more control messages, an indication of a CG for uplink transmissions and a retransmission timer that is specific to the CG. The communications manager 1220 may be configured as or otherwise support a means for receiving a data message in accordance with the CG. The communications manager 1220 may be configured as or otherwise support a means for selecting a time period during which to transmit control information associated with scheduling a retransmission of the data message in accordance with the retransmission timer that is specific to the CG.

Additionally, or alternatively, the communications manager 1220 may support wireless communication at a network entity in accordance with examples as disclosed herein. For example, the communications manager 1220 may be configured as or otherwise support a means for transmitting, via a first set of one or more control messages, a first set of parameters associated with downlink communication from the network entity to a UE. The communications manager 1220 may be configured as or otherwise support a means for transmitting, via a second set of one or more control messages, an indication of a set of resources for a CG for uplink transmissions. The communications manager 1220 may be configured as or otherwise support a means for receiving, over the set of resources, one or more data messages in accordance with the CG using a second set of parameters that are associated with the first set of parameters associated with the downlink communication from the network entity to the UE.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced processing, reduced power consumption, and more efficient utilization of communication resources.

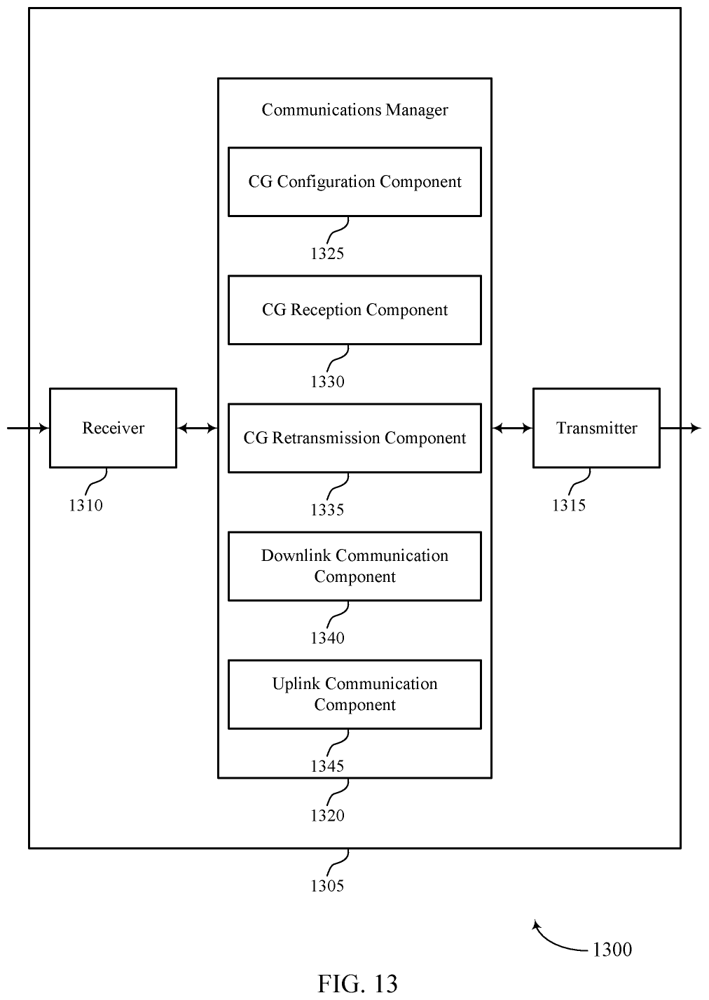

FIG. 13 shows a block diagram 1300 of a device 1305 that supports CG enhancements for XR uplink traffic in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of CG enhancements for XR uplink traffic as described herein. For example, the communications manager 1320 may include a CG configuration component 1325, a CG reception component 1330, a CG retransmission component 1335, a downlink communication component 1340, an uplink communication component 1345, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The CG configuration component 1325 may be configured as or otherwise support a means for transmitting, via one or more control messages, an indication of a CG for uplink transmissions and a retransmission timer that is specific to the CG. The CG reception component 1330 may be configured as or otherwise support a means for receiving a data message in accordance with the CG. The CG retransmission component 1335 may be configured as or otherwise support a means for selecting a time period during which to transmit control information associated with scheduling a retransmission of the data message in accordance with the retransmission timer that is specific to the CG.

Additionally, or alternatively, the communications manager 1320 may support wireless communication at a network entity in accordance with examples as disclosed herein. The downlink communication component 1340 may be configured as or otherwise support a means for transmitting, via a first set of one or more control messages, a first set of parameters associated with downlink communication from the network entity to a UE. The CG configuration component 1325 may be configured as or otherwise support a means for transmitting, via a second set of one or more control messages, an indication of a set of resources for a CG for uplink transmissions. The uplink communication component 1345 may be configured as or otherwise support a means for receiving, over the set of resources, one or more data messages in accordance with the CG using a second set of parameters that are associated with the first set of parameters associated with the downlink communication from the network entity to the UE.

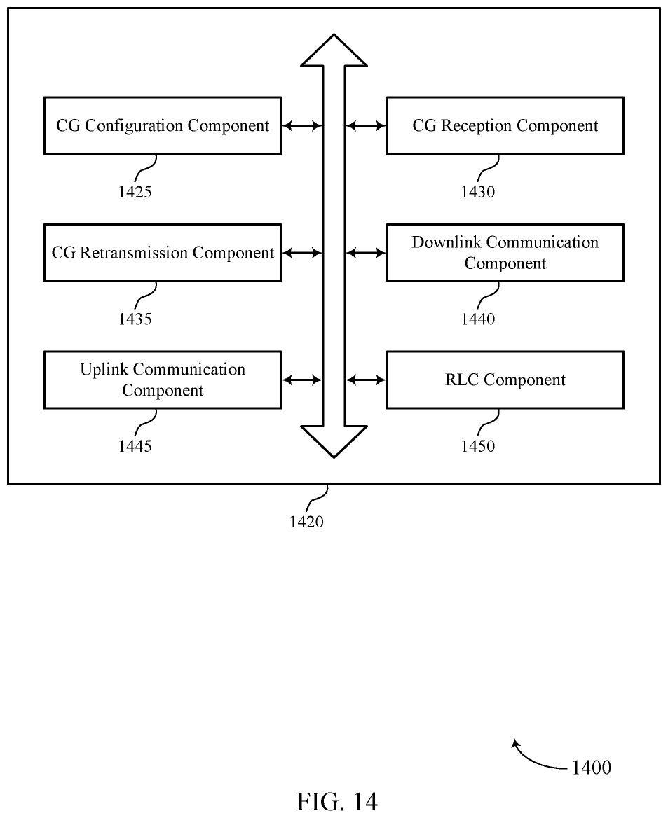

FIG. 14 shows a block diagram 1400 of a communications manager 1420 that supports CG enhancements for XR uplink traffic in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of CG enhancements for XR uplink traffic as described herein. For example, the communications manager 1420 may include a CG configuration component 1425, a CG reception component 1430, a CG retransmission component 1435, a downlink communication component 1440, an uplink communication component 1445, an RLC component 1450, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The CG configuration component 1425 may be configured as or otherwise support a means for transmitting, via one or more control messages, an indication of a CG for uplink transmissions and a retransmission timer that is specific to the CG. The CG reception component 1430 may be configured as or otherwise support a means for receiving a data message in accordance with the CG. The CG retransmission component 1435 may be configured as or otherwise support a means for selecting a time period during which to transmit control information associated with scheduling a retransmission of the data message in accordance with the retransmission timer that is specific to the CG.

In some examples, the CG retransmission component 1435 may be configured as or otherwise support a means for transmitting the control information in accordance with the retransmission timer indicating a non-zero value and a failure to receive the data message.

In some examples, the retransmission timer that is specific to the CG indicates the non-zero value based on the data message to be communicated on the CG being associated with a non-low-latency traffic type. In some examples, the time period is equal to a non-zero quantity of milliseconds in accordance with the retransmission timer indicating the non-zero value.

In some examples, to support selecting the time period during which to transmit the control information, the CG retransmission component 1435 may be configured as or otherwise support a means for selecting not to transmit the control information in accordance with the retransmission timer indicating a zero value.

In some examples, the retransmission timer that is specific to the CG indicates the zero value based on the data message to be communicated on the CG being associated with a low-latency traffic type. In some examples, the time period is equal to zero milliseconds in accordance with the retransmission timer indicating the zero value.

In some examples, to support transmitting the one or more control messages, the CG configuration component 1425 may be configured as or otherwise support a means for transmitting an indication to disable retransmission for the CG, where the indication to disable retransmission is specific to the CG. In some examples, to support transmitting the one or more control messages, the CG retransmission component 1435 may be configured as or otherwise support a means for setting the retransmission timer to a zero value in accordance with the indication to disable retransmission for the CG, where selecting the time period during which to transmit the control information is further in accordance with setting the retransmission timer to the zero value.

In some examples, to support setting the retransmission timer to the zero value, the CG configuration component 1425 may be configured as or otherwise support a means for disabling the retransmission timer. In some examples, to support disabling the retransmission timer, the CG configuration component 1425 may be configured as or otherwise support a means for disabling one or more of a set of retransmission timers associated with the retransmission timer, where the set of retransmission timers includes one or more of a CG timer, a HARQ timer, or an uplink DRX retransmission timer.

In some examples, the RLC component 1450 may be configured as or otherwise support a means for initiating a radio link control unacknowledged mode in accordance with receiving the indication to disable retransmission for the CG.

In some examples, the CG reception component 1430 may be configured as or otherwise support a means for receiving, with the data message and in accordance with the configured grant, a BSR, where selecting the time period during which to transmit the control information is further in accordance with the BSR being transmitted with the data message.

In some examples, the indication is a bit received with the data message. In some examples, a bit value of 1 indicates that the retransmission timer is to be started. In some examples, a bit value of 0 indicates that the retransmission timer is not to be started. In some examples, selecting the time period is associated with whether the retransmission is to be started.

In some examples, the CG reception component 1430 may be configured as or otherwise support a means for receiving, with the data message and in accordance with the configured grant, a BSR, where selecting the time period during which to transmit the control information is further in accordance with the BSR being transmitted with the data message.

In some examples, a reception of the BSR with the data message indicates that the retransmission timer is to be started. In some examples, an absence of the BSR with the data message indicates that the retransmission timer is not to be started. In some examples, selecting the time period is associated with whether the retransmission is to be started.

In some examples, the retransmission timer is specific to a logical channel over which the data message is received. In some examples, the CG is mapped to the logical channel in accordance with a traffic type of the data message to be communicated on the CG.

In some examples, the CG reception component 1430 may be configured as or otherwise support a means for receiving a second data message in accordance with a second CG during a same slot as the data message and the CG based on the retransmission timer that is specific to the CG indicating a zero value.

In some examples, the second data message and the data message can be transmitted during the same slot if the CG and the second CG are contiguous in a frequency domain.

In some examples, the CG retransmission component 1435 may be configured as or otherwise support a means for transmitting the control information associated with scheduling the retransmission of the data message. In some examples, the CG retransmission component 1435 may be configured as or otherwise support a means for failing to receive the retransmission in accordance with the retransmission timer that is specific to the CG indicating a zero value.

In some examples, the retransmission timer indicates a relatively smaller value if the data message is associated with a low-latency traffic type and indicates a relatively larger value if the data message is associated with a non-low-latency traffic type.

In some examples, the retransmission timer is a CG timer parameter or an uplink DRX retransmission timer parameter.

Additionally, or alternatively, the communications manager 1420 may support wireless communication at a network entity in accordance with examples as disclosed herein. The downlink communication component 1440 may be configured as or otherwise support a means for transmitting, via a first set of one or more control messages, a first set of parameters associated with downlink communication from the network entity to a UE. In some examples, the CG configuration component 1425 may be configured as or otherwise support a means for transmitting, via a second set of one or more control messages, an indication of a set of resources for a CG for uplink transmissions. The uplink communication component 1445 may be configured as or otherwise support a means for receiving, over the set of resources, one or more data messages in accordance with the CG using a second set of parameters that are associated with the first set of parameters associated with the downlink communication from the network entity to the UE.

In some examples, transmitting the first set of parameters associated with the downlink communication includes. In some examples, transmitting an indication of a downlink periodicity associated with the downlink communication. In some examples, receiving the one or more data messages in accordance with the CG using the second set of parameters includes. In some examples, receiving the one or more data messages in accordance with an uplink periodicity that is associated with the downlink periodicity.

In some examples, the uplink periodicity is equal to a product of the downlink periodicity and a scaling factor.

In some examples, the uplink communication component 1445 may be configured as or otherwise support a means for determining the uplink periodicity in accordance with a unit conversion from milliseconds to symbols based on the downlink periodicity being defined by milliseconds and the uplink periodicity being defined by symbols.

In some examples, the downlink periodicity is associated with a DRX cycle or an SPS periodicity.

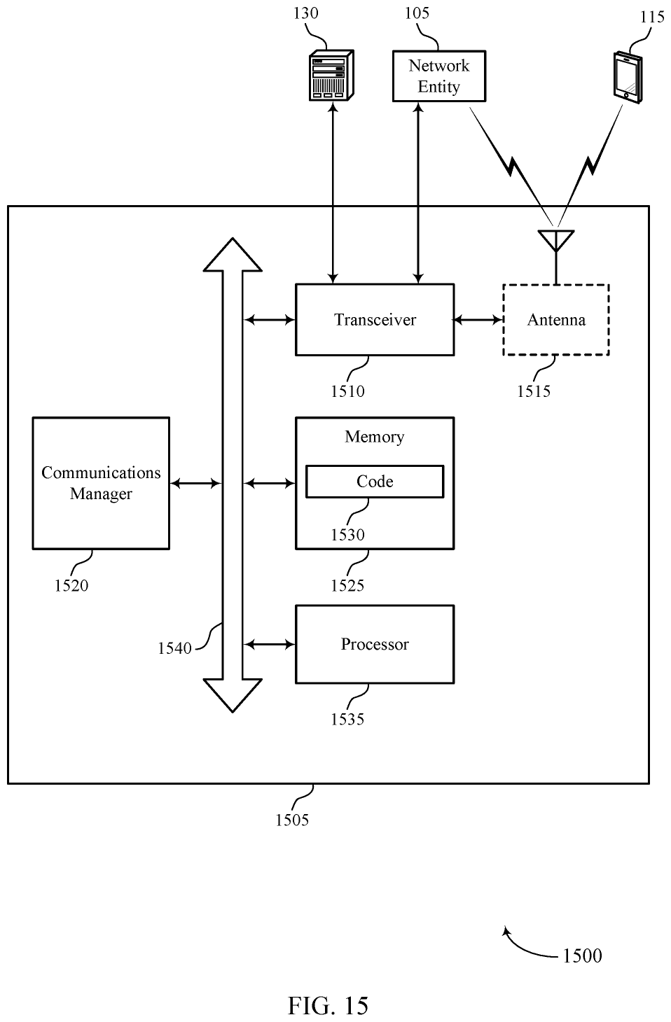

FIG. 15 shows a diagram of a system 1500 including a device 1505 that supports CG enhancements for XR uplink traffic in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, a GPU an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting CG enhancements for XR uplink traffic). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 may be configured as or otherwise support a means for transmitting, via one or more control messages, an indication of a CG for uplink transmissions and a retransmission timer that is specific to the CG. The communications manager 1520 may be configured as or otherwise support a means for receiving a data message in accordance with the CG. The communications manager 1520 may be configured as or otherwise support a means for selecting a time period during which to transmit control information associated with scheduling a retransmission of the data message in accordance with the retransmission timer that is specific to the CG.

Additionally, or alternatively, the communications manager 1520 may support wireless communication at a network entity in accordance with examples as disclosed herein. For example, the communications manager 1520 may be configured as or otherwise support a means for transmitting, via a first set of one or more control messages, a first set of parameters associated with downlink communication from the network entity to a UE. The communications manager 1520 may be configured as or otherwise support a means for transmitting, via a second set of one or more control messages, an indication of a set of resources for a CG for uplink transmissions. The communications manager 1520 may be configured as or otherwise support a means for receiving, over the set of resources, one or more data messages in accordance with the CG using a second set of parameters that are associated with the first set of parameters associated with the downlink communication from the network entity to the UE.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of CG enhancements for XR uplink traffic as described herein, or the processor 1535 and the memory 1525 may be otherwise configured to perform or support such operations.

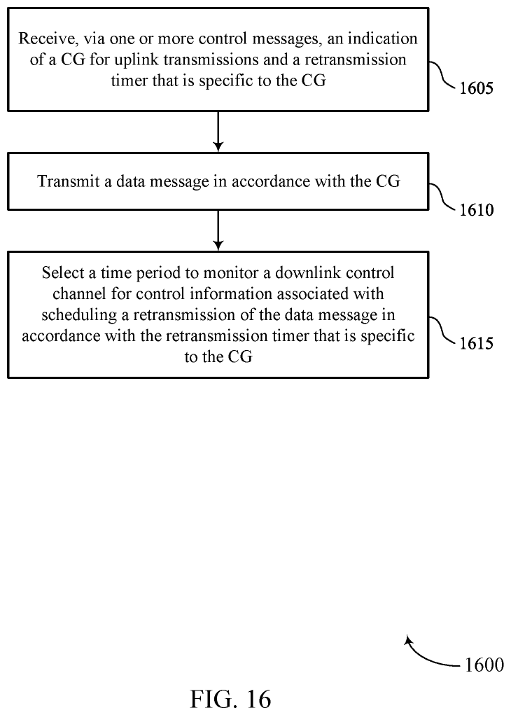

FIG. 16 shows a flowchart illustrating a method 1600 that supports CG enhancements for XR uplink traffic in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, via one or more control messages, an indication of a CG for uplink transmissions and a retransmission timer that is specific to the CG. The operations of 1605 may be performed in accordance with examples as disclosed herein. In some examples, aspects of the operations of 1605 may be performed by a CG configuration component 1025 as described with reference to FIG. 10.

At 1610, the method may include transmitting a data message in accordance with the CG. The operations of 1610 may be performed in accordance with examples as disclosed herein. In some examples, aspects of the operations of 1610 may be performed by a CG transmission component 1030 as described with reference to FIG. 10.

At 1615, the method may include selecting a time period to monitor a downlink control channel for control information associated with scheduling a retransmission of the data message in accordance with the retransmission timer that is specific to the CG. The operations of 1615 may be performed in accordance with examples as disclosed herein. In some examples, aspects of the operations of 1615 may be performed by a monitoring component 1035 as described with reference to FIG. 10.

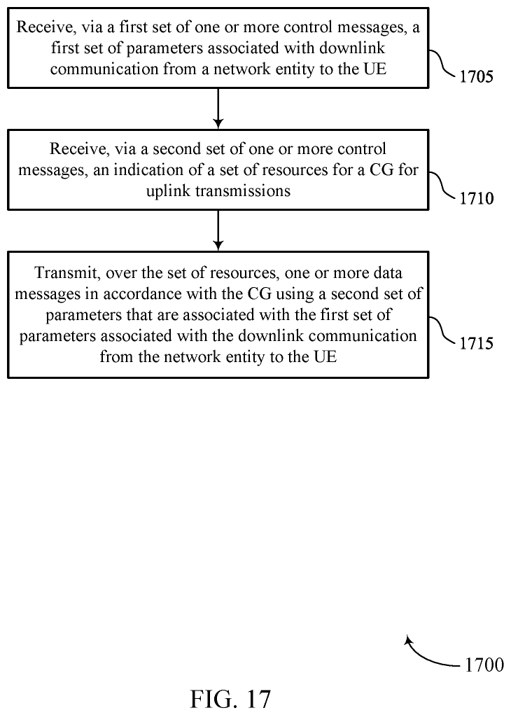

FIG. 17 shows a flowchart illustrating a method 1700 that supports CG enhancements for XR uplink traffic in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving, via a first set of one or more control messages, a first set of parameters associated with downlink communication from a network entity to the UE. The operations of 1705 may be performed in accordance with examples as disclosed herein. In some examples, aspects of the operations of 1705 may be performed by a downlink communication component 1040 as described with reference to FIG. 10.

At 1710, the method may include receiving, via a second set of one or more control messages, an indication of a set of resources for a CG for uplink transmissions. The operations of 1710 may be performed in accordance with examples as disclosed herein. In some examples, aspects of the operations of 1710 may be performed by a CG configuration component 1025 as described with reference to FIG. 10.

At 1715, the method may include transmitting, over the set of resources, one or more data messages in accordance with the CG using a second set of parameters that are associated with the first set of parameters associated with the downlink communication from the network entity to the UE. The operations of 1715 may be performed in accordance with examples as disclosed herein. In some examples, aspects of the operations of 1715 may be performed by an uplink communication component 1045 as described with reference to FIG. 10.

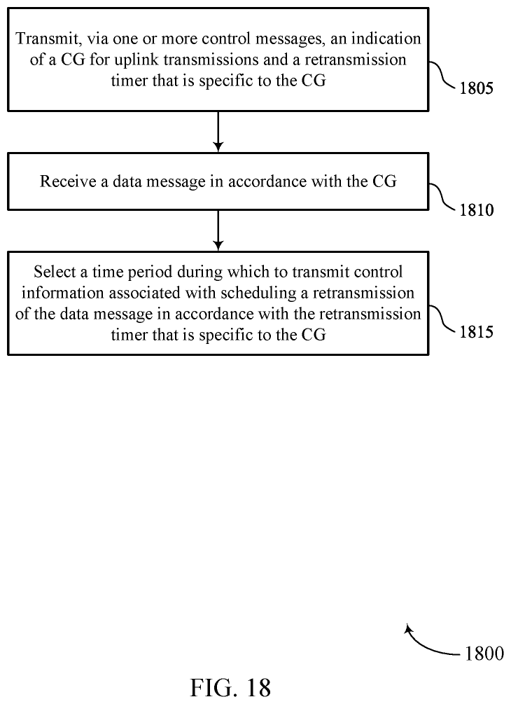

FIG. 18 shows a flowchart illustrating a method 1800 that supports CG enhancements for XR uplink traffic in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, via one or more control messages, an indication of a CG for uplink transmissions and a retransmission timer that is specific to the CG. The operations of 1805 may be performed in accordance with examples as disclosed herein. In some examples, aspects of the operations of 1805 may be performed by a CG configuration component 1425 as described with reference to FIG. 14.

At 1810, the method may include receiving a data message in accordance with the CG. The operations of 1810 may be performed in accordance with examples as disclosed herein. In some examples, aspects of the operations of 1810 may be performed by a CG reception component 1430 as described with reference to FIG. 14.

At 1815, the method may include selecting a time period during which to transmit control information associated with scheduling a retransmission of the data message in accordance with the retransmission timer that is specific to the CG. The operations of 1815 may be performed in accordance with examples as disclosed herein. In some examples, aspects of the operations of 1815 may be performed by a CG retransmission component 1435 as described with reference to FIG. 14.

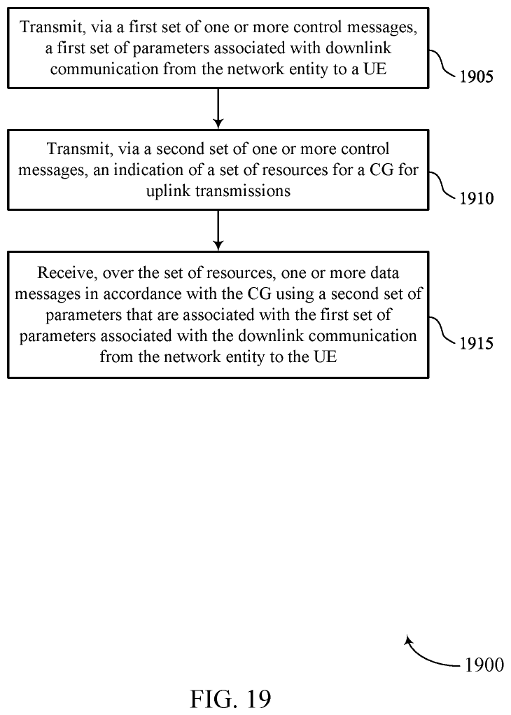

FIG. 19 shows a flowchart illustrating a method 1900 that supports CG enhancements for XR uplink traffic in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, via a first set of one or more control messages, a first set of parameters associated with downlink communication from the network entity to a UE. The operations of 1905 may be performed in accordance with examples as disclosed herein. In some examples, aspects of the operations of 1905 may be performed by a downlink communication component 1440 as described with reference to FIG. 14.

At 1910, the method may include transmitting, via a second set of one or more control messages, an indication of a set of resources for a CG for uplink transmissions. The operations of 1910 may be performed in accordance with examples as disclosed herein. In some examples, aspects of the operations of 1910 may be performed by a CG configuration component 1425 as described with reference to FIG. 14.

At 1915, the method may include receiving, over the set of resources, one or more data messages in accordance with the CG using a second set of parameters that are associated with the first set of parameters associated with the downlink communication from the network entity to the UE. The operations of 1915 may be performed in accordance with examples as disclosed herein. In some examples, aspects of the operations of 1915 may be performed by an uplink communication component 1445 as described with reference to FIG. 14.

The following provides an overview of aspects of the present disclosure:

Aspect 1: A method for wireless communication at a UE, comprising: receiving, via one or more control messages, an indication of a CG for uplink transmissions and a retransmission timer that is specific to the CG; transmitting a data message in accordance with the CG; and selecting a time period to monitor a downlink control channel for control information associated with scheduling a retransmission of the data message in accordance with the retransmission timer that is specific to the CG.

Aspect 2: The method of aspect 1, further comprising: monitoring the downlink control channel for the control information in accordance with the retransmission timer indicating a non-zero value.

Aspect 3: The method of aspect 2, wherein the retransmission timer that is specific to the CG indicates the non-zero value based at least in part on the data message to be communicated on the CG being associated with a non-low-latency traffic type, and the time period is equal to a non-zero quantity of milliseconds in accordance with the retransmission timer indicating the non-zero value.

Aspect 4: The method of any of aspects 1 through 3, wherein selecting the time period to monitor the downlink control channel for the control information comprises: selecting not to monitor the downlink control channel for the control information in accordance with the retransmission timer indicating a zero value.

Aspect 5: The method of aspect 4, wherein the retransmission timer that is specific to the CG indicates the zero value based at least in part on the data message to be communicated on the CG being associated with a low-latency traffic type, and the time period is equal to zero milliseconds in accordance with the retransmission timer indicating the zero value.

Aspect 6: The method of any of aspects 1 through 5, wherein receiving the one or more control messages comprises: receiving an indication to disable retransmission for the CG, wherein the indication to disable retransmission is specific to the CG; and setting the retransmission timer to a zero value in accordance with the indication to disable retransmission for the CG, wherein selecting the time period to monitor the downlink control channel is further in accordance with setting the retransmission timer to the zero value.

Aspect 7: The method of aspect 6, wherein setting the retransmission timer to the zero value comprises disabling the retransmission timer, and wherein disabling the retransmission timer further comprises: disabling one or more of a set of retransmission timers associated with the retransmission timer, where the set of retransmission timers includes one or more of a CG timer, a HARQ timer, or an uplink DRX retransmission timer.

Aspect 8: The method of aspect 6, further comprising: initiating a radio link control unacknowledged mode at the UE in accordance with receiving the indication to disable retransmission for the CG.

Aspect 9: The method of any of aspects 1 through 8, wherein the retransmission timer is specific to a logical channel over which the UE transmits the data message, and the CG is mapped to the logical channel in accordance with a traffic type of the data message to be communicated on the CG.

Aspect 10: The method of any of aspects 1 through 9, further comprising: transmitting a second data message in accordance with a second CG during a same slot as the data message and the CG based at least in part on the retransmission timer that is specific to the CG indicating a zero value.

Aspect 11: The method of aspect 10, wherein the second data message and the data message can be transmitted during the same slot if the CG and the second CG are contiguous in a frequency domain.

Aspect 12: The method of any of aspects 1 through 11, further comprising: receiving the control information associated with scheduling the retransmission of the data message; and ignoring the control information in accordance with the retransmission timer that is specific to the CG indicating a zero value.

Aspect 13: The method of any of aspects 1 through 12, wherein the retransmission timer indicates a relatively smaller value if the data message is associated with a low-latency traffic type and indicates a relatively larger value if the data message is associated with a non-low-latency traffic type.

Aspect 14: The method of any of aspects 1 through 13, wherein the retransmission timer is a CG timer parameter or an uplink DRX retransmission timer parameter.

Aspect 15: The method of any of aspects 1 through 14, further comprising: transmitting, with the data message and in accordance with the configured grant, an indication of whether to start the retransmission timer, wherein selecting the time period to monitor the downlink control channel is further in accordance with the indication of whether to start the retransmission timer.

Aspect 16: The method of aspect 15, wherein the indication is a bit transmitted with the data message, a bit value of 1 indicates that the retransmission timer is to be started, a bit value of 0 indicates that the retransmission timer is not to be started, and selecting the time period is associated with whether the retransmission is to be started.

Aspect 17: The method of any of aspects 1 through 14, further comprising: transmitting, with the data message and in accordance with the configured grant, a BSR, wherein selecting the time period to monitor the downlink control channel is further in accordance with the BSR being transmitted with the data message.

Aspect 18: The method of aspect 17, wherein a transmission of the BSR with the data message indicates that the retransmission timer is to be started, an absence of the BSR with the data message indicates that the retransmission timer is not to be started, and selecting the time period is associated with whether the retransmission is to be started.

Aspect 19: A method for wireless communication at a UE, comprising: receiving, via a first set of one or more control messages, a first set of parameters associated with downlink communication from a network entity to the UE; receiving, via a second set of one or more control messages, an indication of a set of resources for a CG for uplink transmissions; and transmitting, over the set of resources, one or more data messages in accordance with the CG using a second set of parameters that are associated with the first set of parameters associated with the downlink communication from the network entity to the UE.

Aspect 20: The method of aspect 19, wherein receiving the first set of parameters associated with the downlink communication comprises: receiving an indication of a downlink periodicity associated with the downlink communication; and transmitting the one or more data messages in accordance with the CG using the second set of parameters comprises: transmitting the one or more data messages in accordance with an uplink periodicity that is associated with the downlink periodicity.

Aspect 21: The method of aspect 20, wherein the uplink periodicity is equal to a product of the downlink periodicity and a scaling factor.

Aspect 22: The method of any of aspects 20 through 21, further comprising: determining the uplink periodicity in accordance with a unit conversion from milliseconds to symbols based at least in part on the downlink periodicity being defined by milliseconds and the uplink periodicity being defined by symbols.

Aspect 23: The method of any of aspects 20 through 22, wherein the downlink periodicity is associated with a DRX cycle or an SPS periodicity.

Aspect 24: A method for wireless communication at a network entity, comprising: transmitting, via one or more control messages, an indication of a CG for uplink transmissions and a retransmission timer that is specific to the CG; receiving a data message in accordance with the CG; and selecting a time period during which to transmit control information associated with scheduling a retransmission of the data message in accordance with the retransmission timer that is specific to the CG.

Aspect 25: The method of aspect 24, further comprising: transmitting the control information in accordance with the retransmission timer indicating a non-zero value and a failure to receive the data message.

Aspect 26: The method of aspect 25, wherein the retransmission timer that is specific to the CG indicates the non-zero value based at least in part on the data message to be communicated on the CG being associated with a non-low-latency traffic type, and the time period is equal to a non-zero quantity of milliseconds in accordance with the retransmission timer indicating the non-zero value.

Aspect 27: The method of any of aspects 24 through 26, wherein selecting the time period during which to transmit the control information comprises: selecting not to transmit the control information in accordance with the retransmission timer indicating a zero value.

Aspect 28: The method of aspect 27, wherein the retransmission timer that is specific to the CG indicates the zero value based at least in part on the data message to be communicated on the CG being associated with a low-latency traffic type, and the time period is equal to zero milliseconds in accordance with the retransmission timer indicating the zero value.

Aspect 29: The method of any of aspects 24 through 28, wherein transmitting the one or more control messages comprises: transmitting an indication to disable retransmission for the CG, wherein the indication to disable retransmission is specific to the CG; and setting the retransmission timer to a zero value in accordance with the indication to disable retransmission for the CG, wherein selecting the time period during which to transmit the control information is further in accordance with setting the retransmission timer to the zero value.

Aspect 30: The method of aspect 29, wherein setting the retransmission timer to the zero value comprises disabling the retransmission timer, and wherein disabling the retransmission timer further comprises: disabling one or more of a set of retransmission timers associated with the retransmission timer, where the set of retransmission timers includes one or more of a CG timer, a HARQ timer, or an uplink DRX retransmission timer.

Aspect 31: The method of aspect 29, further comprising: initiating a radio link control unacknowledged mode in accordance with receiving the indication to disable retransmission for the CG.

Aspect 32: The method of any of aspects 24 through 31, wherein the retransmission timer is specific to a logical channel over which the data message is received, and the CG is mapped to the logical channel in accordance with a traffic type of the data message to be communicated on the CG.

Aspect 33: The method of any of aspects 24 through 32, further comprising: receiving a second data message in accordance with a second CG during a same slot as the data message and the CG based at least in part on the retransmission timer that is specific to the CG indicating a zero value.

Aspect 34: The method of aspect 33, wherein the second data message and the data message can be transmitted during the same slot if the CG and the second CG are contiguous in a frequency domain.

Aspect 35: The method of any of aspects 24 through 34, further comprising: transmitting the control information associated with scheduling the retransmission of the data message; and failing to receive the retransmission in accordance with the retransmission timer that is specific to the CG indicating a zero value.

Aspect 36: The method of any of aspects 24 through 35, wherein the retransmission timer indicates a relatively smaller value if the data message is associated with a low-latency traffic type and indicates a relatively larger value if the data message is associated with a non-low-latency traffic type.

Aspect 37: The method of any of aspects 24 through 36, wherein the retransmission timer is a CG timer parameter or an uplink DRX retransmission timer parameter.

Aspect 38: The method of any of aspects 24 through 37, further comprising: receiving, with the data message and in accordance with the configured grant, a BSR, wherein selecting the time period during which to transmit the control information is further in accordance with the BSR being transmitted with the data message.

Aspect 39: The method of aspect 38, wherein the indication is a bit received with the data message, a bit value of 1 indicates that the retransmission timer is to be started, a bit value of 0 indicates that the retransmission timer is not to be started, and selecting the time period is associated with whether the retransmission is to be started.

Aspect 40: The method of any of aspects 25 through 37, further comprising: receiving, with the data message and in accordance with the configured grant, a BSR, wherein selecting the time period during which to transmit the control information is further in accordance with the BSR being transmitted with the data message.

Aspect 41: The method of aspect 40, wherein a reception of the BSR with the data message indicates that the retransmission timer is to be started, an absence of the BSR with the data message indicates that the retransmission timer is not to be started, and selecting the time period is associated with whether the retransmission is to be started.

Aspect 42: A method for wireless communication at a network entity, comprising: transmitting, via a first set of one or more control messages, a first set of parameters associated with downlink communication from the network entity to a UE; transmitting, via a second set of one or more control messages, an indication of a set of resources for a CG for uplink transmissions; and receiving, over the set of resources, one or more data messages in accordance with the CG using a second set of parameters that are associated with the first set of parameters associated with the downlink communication from the network entity to the UE.

Aspect 43: The method of aspect 42, wherein transmitting the first set of parameters associated with the downlink communication comprises: transmitting an indication of a downlink periodicity associated with the downlink communication; and receiving the one or more data messages in accordance with the CG using the second set of parameters comprises: receiving the one or more data messages in accordance with an uplink periodicity that is associated with the downlink periodicity.

Aspect 44: The method of aspect 43, wherein the uplink periodicity is equal to a product of the downlink periodicity and a scaling factor.

Aspect 45: The method of any of aspects 43 through 44, further comprising: determining the uplink periodicity in accordance with a unit conversion from milliseconds to symbols based at least in part on the downlink periodicity being defined by milliseconds and the uplink periodicity being defined by symbols.

Aspect 46: The method of any of aspects 43 through 45, wherein the downlink periodicity is associated with a DRX cycle or an SPS periodicity.

Aspect 47: An apparatus for wireless communication at a UE, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 1 through 18.

Aspect 48: An apparatus for wireless communication at a UE, comprising at least one means for performing a method of any of aspects 1 through 18.

Aspect 49: A non-transitory computer-readable medium storing code for wireless communication at a UE, the code comprising instructions executable by at least one processor (e.g., directly, indirectly, after pre-processing, without pre-processing) to perform a method of any of aspects 1 through 18.

Aspect 50: An apparatus for wireless communication at a UE, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 19 through 23.

Aspect 51: An apparatus for wireless communication at a UE, comprising at least one means for performing a method of any of aspects 19 through 23.

Aspect 52: A non-transitory computer-readable medium storing code for wireless communication at a UE, the code comprising instructions executable by at least one processor (e.g., directly, indirectly, after pre-processing, without pre-processing) to perform a method of any of aspects 19 through 23.

Aspect 53: An apparatus for wireless communication at a network entity, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 24 through 41.

Aspect 54: An apparatus for wireless communication at a network entity, comprising at least one means for performing a method of any of aspects 24 through 41.

Aspect 55: A non-transitory computer-readable medium storing code for wireless communication at a network entity, the code comprising instructions executable by at least one processor (e.g., directly, indirectly, after pre-processing, without pre-processing) to perform a method of any of aspects 24 through 41.

Aspect 56: An apparatus for wireless communication at a network entity, comprising at least one processor; memory coupled (e.g., operatively, communicatively, functionally, electronically, or electrically) with the at least one processor; and instructions stored in the memory and executable by the at least one processor (e.g., directly, indirectly, after pre-processing, without pre-processing) to cause the apparatus to perform a method of any of aspects 42 through 46.

Aspect 57: An apparatus for wireless communication at a network entity, comprising at least one means for performing a method of any of aspects 42 through 46.

Aspect 58: A non-transitory computer-readable medium storing code for wireless communication at a network entity, the code comprising instructions executable by at least one processor (e.g., directly, indirectly, after pre-processing, without pre-processing) to perform a method of any of aspects 42 through 46.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), or ascertaining. Also, “determining” or “identifying” can include receiving (such as receiving information or signaling, e.g., receiving information or signaling for determining, receiving information or signaling for identifying), or accessing (such as accessing data in a memory, or accessing information). Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
receive, via one or more control messages, an indication of a configured grant for uplink transmissions and a retransmission timer that is specific to the configured grant;
transmit a data message in accordance with the configured grant; and
select a time period to monitor a downlink control channel for control information associated with scheduling a retransmission of the data message in accordance with the retransmission timer that is specific to the configured grant.

2. The apparatus of claim 1, wherein the instructions are further executable by the at least one processor to cause the UE to:
monitor the downlink control channel for the control information in accordance with the retransmission timer indicating a non-zero value.

3. The apparatus of claim 2, wherein:
the retransmission timer that is specific to the configured grant indicates the non-zero value based at least in part on the data message to be communicated on the configured grant being associated with a non-low-latency traffic type; and
the time period is equal to a non-zero quantity of milliseconds in accordance with the retransmission timer indicating the non-zero value.

4. The apparatus of claim 1, wherein the instructions to select the time period to monitor the downlink control channel for the control information are executable by the at least one processor to cause the UE to:
select not to monitor the downlink control channel for the control information in accordance with the retransmission timer indicating a zero value.

5. The apparatus of claim 4, wherein:
the retransmission timer that is specific to the configured grant indicates the zero value based at least in part on the data message to be communicated on the configured grant being associated with a low-latency traffic type; and
the time period is equal to zero milliseconds in accordance with the retransmission timer indicating the zero value.

6. The apparatus of claim 1, wherein the instructions to receive the one or more control messages are executable by the at least one processor to cause the UE to:
receive an indication to disable retransmission for the configured grant, wherein the indication to disable retransmission is specific to the configured grant; and
set the retransmission timer to a zero value in accordance with the indication to disable retransmission for the configured grant, wherein selecting the time period to monitor the downlink control channel is further in accordance with setting the retransmission timer to the zero value.

7. The apparatus of claim 6, wherein the instructions to set the retransmission timer to the zero value are further executable by the at least one processor to cause the UE to disable the retransmission timer, and wherein, to disable the retransmission timer, the instructions are further executable by the at least one processor to cause the UE to:
disable one or more of a set of retransmission timers associated with the retransmission timer, wherein the set of retransmission timers includes one or more of a configured grant timer, a hybrid automatic repeat request (HARQ) timer, or an uplink discontinuous reception retransmission timer.

8. The apparatus of claim 6, wherein the instructions are further executable by the at least one processor to cause the UE to:
initiate a radio link control unacknowledged mode at the UE in accordance with receiving the indication to disable retransmission for the configured grant.

9. The apparatus of claim 1, wherein the instructions are further executable by the at least one processor to cause the UE to:
transmit, with the data message and in accordance with the configured grant, an indication of whether to start the retransmission timer, wherein selecting the time period to monitor the downlink control channel is further in accordance with the indication of whether to start the retransmission timer.

10. The apparatus of claim 9, wherein the indication is a bit transmitted with the data message, wherein a bit value of 1 indicates that the retransmission timer is to be started, wherein a bit value of 0 indicates that the retransmission timer is not to be started, and wherein selecting the time period is associated with whether the retransmission is to be started.

11. The apparatus of claim 1, wherein the instructions are further executable by the at least one processor to cause the UE to:
transmit, with the data message and in accordance with the configured grant, a buffer status report, wherein selecting the time period to monitor the downlink control channel is further in accordance with the buffer status report being transmitted with the data message.

12. The apparatus of claim 11, wherein a transmission of the buffer status report with the data message indicates that the retransmission timer is to be started, wherein an absence of the buffer status report with the data message indicates that the retransmission timer is not to be started, and wherein selecting the time period is associated with whether the retransmission is to be started.

13. The apparatus of claim 1, wherein:
the retransmission timer is specific to a logical channel over which the UE transmits the data message; and
the configured grant is mapped to the logical channel in accordance with a traffic type of the data message to be communicated on the configured grant.

14. The apparatus of claim 1, wherein the instructions are further executable by the at least one processor to cause the UE to:
transmit a second data message in accordance with a second configured grant during a same slot as the data message and the configured grant based at least in part on the retransmission timer that is specific to the configured grant indicating a zero value.

15. The apparatus of claim 14, wherein the second data message and the data message can be transmitted during the same slot if the configured grant and the second configured grant are contiguous in a frequency domain.

16. The apparatus of claim 1, wherein the instructions are further executable by the at least one processor to cause the UE to:
receive the control information associated with scheduling the retransmission of the data message; and
ignore the control information in accordance with the retransmission timer that is specific to the configured grant indicating a zero value.

17. The apparatus of claim 1, wherein the retransmission timer indicates a relatively smaller value if the data message is associated with a low-latency traffic type and indicates a relatively larger value if the data message is associated with a non-low-latency traffic type.

18. The apparatus of claim 1, wherein the retransmission timer is associated with one or more of a configured grant timer parameter, a hybrid automatic repeat request (HARQ) timer parameter, or an uplink discontinuous reception retransmission timer parameter.

19. An apparatus for wireless communication at a network entity, comprising:
at least one processor; and
memory coupled with the at least one processor, the memory storing instructions executable by the at least one processor to cause the network entity to:
transmit, via one or more control messages, an indication of a configured grant for uplink transmissions and a retransmission timer that is specific to the configured grant;
receive a data message in accordance with the configured grant; and
select a time period during which to transmit control information associated with scheduling a retransmission of the data message in accordance with the retransmission timer that is specific to the configured grant.

20. The apparatus of claim 19, wherein the instructions are further executable by the at least one processor to cause the network entity to:
transmit the control information in accordance with the retransmission timer indicating a non-zero value and a failure to receive the data message.

21. The apparatus of claim 20, wherein:
the retransmission timer that is specific to the configured grant indicates the non-zero value based at least in part on the data message to be communicated on the configured grant being associated with a non-low-latency traffic type; and
the time period is equal to a non-zero quantity of milliseconds in accordance with the retransmission timer indicating the non-zero value.

22. The apparatus of claim 19, wherein the instructions to select the time period during which to transmit the control information are executable by the at least one processor to cause the network entity to:
select not to transmit the control information in accordance with the retransmission timer indicating a zero value.

23. The apparatus of claim 22, wherein:
the retransmission timer that is specific to the configured grant indicates the zero value based at least in part on the data message to be communicated on the configured grant being associated with a low-latency traffic type; and
the time period is equal to zero milliseconds in accordance with the retransmission timer indicating the zero value.

24. The apparatus of claim 19, wherein the instructions to transmit the one or more control messages are executable by the at least one processor to cause the network entity to:
transmit an indication to disable retransmission for the configured grant, wherein the indication to disable retransmission is specific to the configured grant; and
set the retransmission timer to a zero value in accordance with the indication to disable retransmission for the configured grant, wherein selecting the time period during which to transmit the control information is further in accordance with setting the retransmission timer to the zero value.

25. The apparatus of claim 24, wherein the instructions are further executable by the at least one processor to cause the network entity to:
initiate a radio link control unacknowledged mode in accordance with receiving the indication to disable retransmission for the configured grant.

26. The apparatus of claim 19, wherein the instructions are further executable by the at least one processor to cause the network entity to:
receive, with the data message and in accordance with the configured grant, a buffer status report, wherein selecting the time period during which to transmit the control information is further in accordance with the buffer status report being transmitted with the data message.

27. The apparatus of claim 26, wherein the indication is a bit received with the data message, wherein a bit value of 1 indicates that the retransmission timer is to be started, wherein a bit value of 0 indicates that the retransmission timer is not to be started, and wherein selecting the time period is associated with whether the retransmission is to be started.

28. The apparatus of claim 19, wherein the instructions are further executable by the at least one processor to cause the network entity to:
receive, with the data message and in accordance with the configured grant, a buffer status report, wherein selecting the time period during which to transmit the control information is further in accordance with the buffer status report being transmitted with the data message.

29. A method for wireless communication at a user equipment (UE), comprising:
receiving, via one or more control messages, an indication of a configured grant for uplink transmissions and a retransmission timer that is specific to the configured grant;
transmitting a data message in accordance with the configured grant; and
selecting a time period to monitor a downlink control channel for control information associated with scheduling a retransmission of the data message in accordance with the retransmission timer that is specific to the configured grant.

30. A method for wireless communication at a network entity, comprising:
transmitting, via one or more control messages, an indication of a configured grant for uplink transmissions and a retransmission timer that is specific to the configured grant;
receiving a data message in accordance with the configured grant; and
selecting a time period during which to transmit control information associated with scheduling a retransmission of the data message in accordance with the retransmission timer that is specific to the configured grant.
